(19) United States
(12) Patent Application Publication
(10) Pub. No.: US 2026/0289434 A1
(43) Pub. Date: Sep. 24, 2026

(54) SYSTEM

(71) Applicant: SoftBank Group Corp., Tokyo (JP)

(72) Inventor: Miho FUJII, Tokyo (JP)

(73) Assignee: SoftBank Group Corp., Tokyo (JP)

(21) Appl. No.: 19/564,450

(22) Filed: Mar. 12, 2026

(30) Foreign Application Priority Data
Mar. 19, 2025 (JP) 2025-044481

(51) Int. Cl. G06Q 10/02; G06N 3/0475

(52) U.S. Cl. CPC G06Q 10/025; G06N 3/0475

(57) ABSTRACT

A system includes a processor that is configured to input, as a prompt, user intent that reflects a preference of a user, and generate an outing plan by using a generative artificial intelligence model based on the prompt, input reservation information based on a selection made by the user, and confirm a reservation for at least one of an accommodation facility and a transportation facility by using an online reservation system, and recognize an emotion of the user through at least one of a sensor and an input device, and dynamically adjust the outing plan based on the emotion by using an emotion engine.

### CROSS-REFERENCE TO RELATED APPLICATION

This application is based on and claims priority under 35 USC 119 from Japanese Patent Application No. 2025-044481 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel and outing planning systems require the user to manually search for information, create an itinerary, and perform reservations for accommodations and transportation through multiple separate services. Even when some degree of automation is provided, such systems typically generate fixed plans that do not adequately reflect the user's detailed intent and preferences, and that do not dynamically respond to the user's emotional state during the planning or execution phases of the outing. Furthermore, conventional systems generally lack an integrated mechanism for coordinating with navigation applications while simultaneously taking into account real-time congestion information to calculate and propose optimal routes. As a result, the user is burdened with repeated manual adjustments to the travel plan, experiences reduced satisfaction when the plan does not match the user's emotional condition, and may be forced to follow suboptimal routes that are crowded or inconvenient.

### SUMMARY

In order to solve at least part of the above-described problems, a system according to one aspect of the present invention comprises a processor configured to input, as a prompt, user intent that reflects a preference of a user, and generate an outing plan by using a generative artificial intelligence model based on the prompt. The processor is further configured to input reservation information based on a selection made by the user, and confirm a reservation for at least one of an accommodation facility and a transportation facility by using an online reservation system. The processor is also configured to recognize an emotion of the user through at least one of a sensor and an input device, and dynamically adjust the outing plan based on the emotion by using an emotion engine. In some embodiments, the processor is configured to adjust the outing plan based on emotion information obtained by an emotion analysis unit that analyzes the user's emotional state. In additional embodiments, the processor is configured to perform inter-application coordination with a navigation application, calculate an optimal route by taking into account congestion information acquired in real time, and propose the optimal route to the user, thereby enabling an integrated system that flexibly generates, updates, and guides an outing plan in accordance with both the user's intent and real-world conditions.

The term “processor” refers to one or more hardware processing units and/or processing circuits, such as a central processing unit (CPU), a graphics processing unit (GPU), a system on chip (SoC), or any combination thereof, capable of executing instructions to implement the functions described herein.

The term “user intent” refers to information indicating a desired purpose, preference, condition, or constraint of a user regarding an outing or travel, including but not limited to destination, schedule, budget, favored activities, and aversions such as avoiding crowds.

The term “prompt” refers to data provided to a generative artificial intelligence model as an input instruction or query, including natural language text and optional structured parameters, which guides the model in generating an outing plan.

The term “generative artificial intelligence model” refers to a machine learning model trained on data to generate new content, such as text, schedules, or recommendations, in response to a given prompt, and may include large language models and related generative models.

The term “outing plan” refers to a plan that includes at least one of an itinerary, a list of places to visit, time schedules, and associated accommodations and transportation options for an outing or travel of the user.

The term “reservation information” refers to information required to make a booking through an online reservation system, including at least identification of an accommodation facility or transportation facility, dates and times, number of persons, and user identification or payment-related details.

The term “accommodation facility” refers to a facility that provides lodging services to the user, such as a hotel, inn, guest house, or rental property.

The term “transportation facility” refers to a transportation service or means used for moving the user, such as a train, bus, airplane, ship, taxi, or ride-sharing service, including infrastructure and associated booking systems.

The term “online reservation system” refers to a computer-based system accessible via a network that enables creation, modification, and confirmation of reservations for at least one of accommodation facilities and transportation facilities.

The term “emotion” refers to an internal affective state of the user, such as happiness, stress, anxiety, excitement, or fatigue, which can be inferred or recognized from measurable signals.

The term “sensor” refers to a device that detects a physical quantity related to the user and converts it into a signal, including but not limited to cameras, microphones, heart rate sensors, wearable device sensors, and environmental sensors.

The term “input device” refers to a device through which the user explicitly inputs information, including but not limited to a keyboard, mouse, touch panel, microphone for voice input, or any graphical user interface component.

The term “emotion engine” refers to a software and/or hardware component executed by the processor that recognizes or interprets the emotion of the user based on signals from at least one of a sensor and an input device, and that controls dynamic adjustment of the outing plan in response to the recognized emotion.

The term “emotion analysis unit” refers to a functional module that analyzes data obtained from sensors, input devices, or other sources to derive emotion information representing the emotional state of the user.

The term “emotion information” refers to data representing a result of analyzing the emotion of the user, including at least one of emotion type, intensity, temporal changes, or context.

The term “dynamic adjustment of the outing plan” refers to modification, reconfiguration, or re-generation of at least a part of the outing plan during planning or execution, based on changes in emotion, user input, external conditions, or system analysis, without requiring the user to manually recreate the entire plan.

The term “inter-application coordination” refers to a process in which the processor exchanges data or commands with a separate application, such as a navigation application, via an application programming interface, deep link, intent, or other communication mechanism, so that the applications operate cooperatively.

The term “navigation application” refers to an application that calculates, displays, or guides routes on a map for the user, and may provide turn-by-turn navigation, real-time traffic information, and route optimization.

The term “congestion information” refers to information indicating a degree of crowding, traffic density, or usage level of transportation routes, facilities, or places, and may be obtained from real-time data sources, historical data, or predictive models.

The term “optimal route” refers to a route calculated by the processor that satisfies at least one criterion such as minimizing travel time, avoiding congestion, reducing cost, or improving user comfort, optionally in accordance with user intent and emotion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

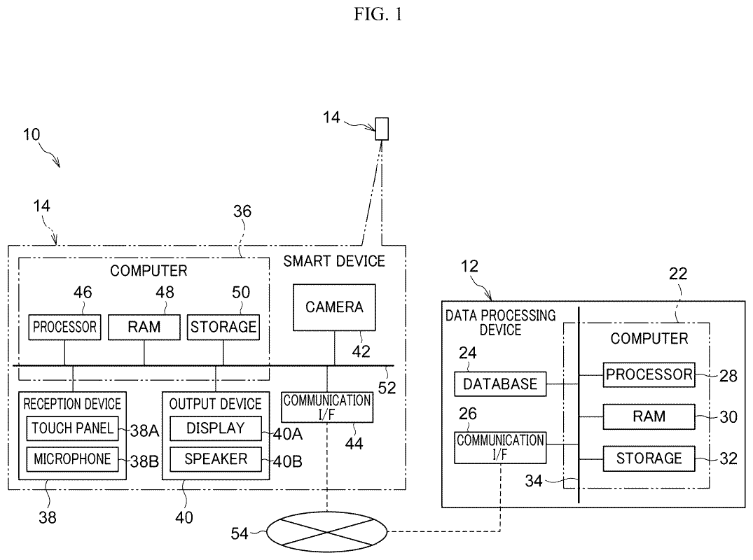

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

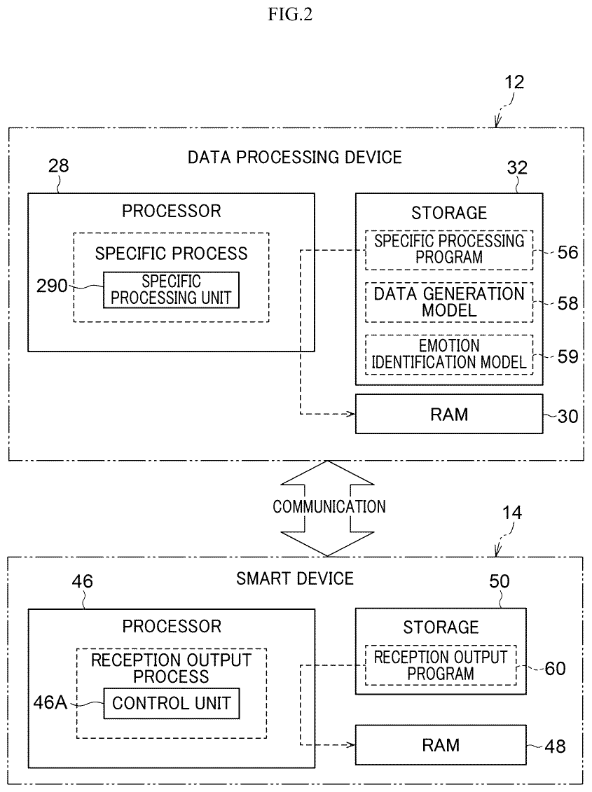

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional itinerary planning systems and reservation platforms rely on rigid rule-based engines and manually predefined workflows. Such systems typically treat user input, external service responses, and contextual data (such as weather, congestion, and discounts) as separate, loosely coupled information sources. As a result, these systems suffer from several technical problems. First, conventional systems are not configured to accept rich natural language instructions from a user as a machine-processable prompt sentence and to use such prompt sentences as unified control input for downstream processing. Instead, they require the user to fill out multiple structured forms, which leads to fragmented intent representation and increased processing overhead for translating user intent into system-internal representations.

Second, existing travel planning architectures generally do not employ a generative AI model as a core computational component for synthesizing an integrated, machine-readable outing plan. Even when machine learning is used, it is often limited to recommendation scoring, and the system must still perform complex post-processing to transform disparate outputs into a coherent, structured plan. This causes duplicated data transformations, increased memory access, and inefficient CPU/GPU utilization.

Third, typical server systems that interact with external reservation systems, weather services, map services, congestion services, coupon services, and regional information databases handle these integrations in an ad-hoc, sequential, and uncoordinated manner. The server must repeatedly query each external resource independently, maintain separate intermediate state for each service, and then merge the responses procedurally at the application level. This leads to non-optimized network traffic patterns, redundant I/O operations, and an increased number of conversions between text and structured data, thereby degrading overall system performance and scalability.

Fourth, conventional systems seldom integrate real-time user emotion analysis into the core planning pipeline as a first-class computational input. User emotion, if handled at all, is typically processed at the user interface layer and not fed back into the itinerary generation and optimization logic on the server. As a consequence, the server cannot dynamically adjust data structures representing the outing plan in response to emotion signals, and is unable to re-invoke external services or the generative AI model in a coordinated fashion. This results in static or only superficially adapted plans, and wastes opportunities to improve the relevance and efficiency of computation based on user state.

Fifth, known systems handling route calculation and congestion information usually overlay congestion annotations on precomputed routes without re-optimizing the underlying route graph or itinerary structure. This produces a passive information display rather than an active, congestion-aware reconfiguration of movement segments. Accordingly, the server must recompute routes manually in a piecemeal fashion if the user wishes to avoid congestion, which increases processing latency and causes repeated calls to external route search services.

Therefore, there is a need for an improved computer-implemented system and processing architecture that (i) treats a natural language prompt sentence as a primary, unified control input; (ii) uses a generative AI model to generate and maintain a structured outing plan as a central data structure; (iii) orchestrates external reservation, weather, route, congestion, coupon, and regional information services around that structured plan; and (iv) dynamically updates the structured plan on the basis of real-time emotion analysis, while reducing redundant data transformations, network calls, and state management overhead in the server. Such an architecture improves the functioning of the computer system itself by optimizing how the processor allocates resources, interacts with external services, and maintains consistent structured representations of complex, multi-source travel data.

The specific processing by the specific processing unit 290 of the data processing device 12 in Example 1 is realized by the following means.

The present invention provides a server comprising a processor configured to receive, from a user terminal, user preference information relating to an outing as a natural language prompt sentence, to construct the prompt sentence as input data for a generative AI model, to generate, by using the generative AI model, an outing plan as structured data including at least a candidate visiting location, a time allocation, and a cost allocation, to extract reservation request information from the outing plan and interact with an external reservation processing apparatus to obtain candidate service information and confirm a reservation, to acquire weather information, movement route information, congestion degree information, discount or benefit information, and region-specific information from corresponding external information sources, to integrate the acquired information into the structured outing plan, to generate emotion information by analyzing an emotional state of a user acquired via a sensor or an input device, to dynamically adjust contents of the structured outing plan on the basis of the emotion information and the output of the generative AI model, and to generate and transmit integrated behavioral plan data, including the adjusted outing plan and the integrated external information, to the user terminal. This enables the computer system to operate with an improved internal architecture that uses a unified, machine-readable itinerary representation driven by a generative AI model and emotion analysis, reduces redundant data transformations and external service calls by organizing all external interactions around the structured outing plan, dynamically reconfigures routes and activities in response to congestion and user emotion signals, and thereby enhances processing efficiency, scalability, and responsiveness of the server in generating and updating complex, multi-source travel plans.

The term “user terminal” refers to an information processing apparatus operated by a user, such as a portable communication device or a computing device, that is configured to transmit user input to a server and receive and display data including an outing plan.

The term “user preference information” refers to data representing a user's intent or conditions relating to an outing, including at least a destination, a date and time, a budget, an interest, a constraint, or a desired activity.

The term “natural language prompt sentence” refers to a character string expressed in a human language that encodes the user preference information and is formatted to be directly input to a generative AI model as control data for generating an outing plan.

The term “generative AI model” refers to a machine learning model, such as a neural network model trained on data, that is configured to output generated content including a structured outing plan based on an input prompt sentence.

The term “information processing apparatus” refers to a hardware and software configuration including at least a processor and a memory that is capable of executing programs to perform data processing, model inference, communication, and storage operations.

The term “outing plan” refers to a data structure representing a planned sequence of activities for an outing or travel, including at least a candidate visiting location, a time allocation, and a cost allocation for one or more segments of the outing.

The term “structured data” refers to data organized in a predefined format, such as a record, a table, or a hierarchical object, in which elements including a date, a time, a location, and a cost are explicitly represented in machine-readable fields.

The term “candidate visiting location” refers to a place or area proposed to be visited during an outing, represented as data including at least a location identifier, a geographic position, or a place name.

The term “time allocation” refers to data indicating a scheduled time or time range associated with an activity or visiting location within the outing plan.

The term “cost allocation” refers to data indicating an estimated or allocated monetary amount associated with an activity, a visiting location, or a segment of the outing plan.

The term “historical behavior information” refers to data describing past activities of the user, such as previously visited locations, past outing plans, or realized routes, stored by the system for use in generating new outing plans.

The term “preference information” refers to data describing tendencies or likes of the user, such as favored activity types, spending patterns, or travel styles, derived from user input or historical behavior information.

The term “reservation request information” refers to data extracted from the outing plan that specifies a need for a resource, such as an accommodation resource or a transportation resource, including at least a date and time, a location, a service type, and a quantity.

The term “external reservation processing apparatus” refers to an information processing system provided outside the server, which is configured to receive reservation request information via a communication network, search for a service candidate, and return reservation information.

The term “accommodation behavior” refers to a segment of the outing plan that requires use of a lodging service, including at least a stay date, a stay duration, or a lodging location.

The term “movement behavior” refers to a segment of the outing plan that involves transportation between two or more locations, including at least a departure location, an arrival location, and a travel time.

The term “candidate service information” refers to data returned from the external reservation processing apparatus that represents one or more possible services satisfying the reservation request information, including at least availability information and pricing information.

The term “reservation identification information” refers to data uniquely identifying a confirmed reservation, such as a reservation number or a confirmation code, which is stored in association with the outing plan.

The term “weather information” refers to data representing atmospheric conditions for a specified place and time, such as temperature, precipitation, or forecast conditions, obtained from an external weather information source.

The term “action segment” refers to a unit element of the outing plan that corresponds to a specific activity, stay, movement, or time period within the outing.

The term “route search processing apparatus” refers to an information processing system that is configured to calculate movement route information between two or more locations based on input parameters including a position and a time.

The term “movement route information” refers to data representing a path or sequence of travel steps between locations, including at least a route, a travel time, or a travel mode.

The term “external congestion information providing apparatus” refers to an information processing system that supplies data indicating a congestion degree of an area or route, based on traffic, crowd, or usage conditions.

The term “congestion degree information” refers to data indicating a level of congestion for a given area or route, represented as qualitative or quantitative values used to determine whether the area or route is crowded.

The term “threshold” refers to a predetermined criterion value used for comparing with congestion degree information to determine whether a congestion level is considered high or low.

The term “alternative route information” refers to movement route information different from a previously obtained route, which is recalculated to satisfy a condition such as a lower congestion degree or a different travel constraint.

The term “external benefit information providing apparatus” refers to an information processing system that provides discount information or other benefit information associated with a location, a time, or a usage type, such as a promotional offer for a service.

The term “discount information” refers to data representing a reduction in price or a special pricing condition applicable to a service, a product, or an activity during the outing.

The term “benefit information” refers to data representing a special advantage, such as a coupon, a bonus service, or a loyalty reward, that can be applied during the outing.

The term “usage type” refers to a classification of how a place or service is used, such as dining, lodging, transportation, or shopping.

The term “regional information database” refers to a data storage system that maintains records related to regions, including at least region-specific items, tourism resources, or related metadata.

The term “region-specific item information” refers to data describing items characteristic of a particular region, such as local products, specialty goods, or recommended purchasable items.

The term “tourism resource information” refers to data describing points of interest, attractions, or cultural resources within a region that are relevant to sightseeing or recreational activities.

The term “stay segment” refers to an action segment in the outing plan that indicates staying at or remaining in a particular location for a period of time.

The term “purchase segment” refers to an action segment in the outing plan that indicates an opportunity or plan to acquire goods or services, such as shopping or ticket purchase.

The term “sensor” refers to a device that detects a physical or physiological signal related to the user, such as motion, biometric data, or environmental input, and converts it into electronic data.

The term “input device” refers to a hardware interface through which the user provides data to the system, such as a pointing device, a keyboard, a touch screen, or a microphone.

The term “emotion analysis unit” refers to a functional component implemented by hardware and software that processes data acquired from a sensor or an input device to infer an emotional state of the user.

The term “emotion information” refers to data representing an inferred emotional state or change in emotional state of the user, such as stress, satisfaction, or fatigue levels.

The term “emotion engine” refers to a functional component implemented by hardware and software that adjusts parameters of the outing plan based on emotion information and other contextual data.

The term “visiting order” refers to data indicating the sequence in which candidate visiting locations are to be visited within the outing plan.

The term “stay time” refers to data indicating a duration for which the user is planned to remain at a particular location or activity.

The term “activity type” refers to a kind or category of an action included in the outing plan, such as sightseeing, dining, shopping, or transit.

The term “integrated behavioral plan data” refers to a data set obtained by combining the structured outing plan with related external information including reservation identification information, weather information, movement route information, discount or benefit information, region-specific item information, and congestion degree information, in a unified, machine-readable format.

In one embodiment of the present invention, a server, a terminal, and a user cooperate to realize a system that generates, updates, and delivers a structured outing plan based on a natural language prompt sentence, external information sources, and emotion analysis.

### A. Hardware and Software Configuration

The server uses one or more information processing devices each including at least a central processing unit (CPU), a main memory, a non-volatile storage device, and a communication interface. The server optionally uses an accelerator, such as a graphics processing unit (GPU), for inference of a generative AI model. As concrete examples, the server uses a multi-core CPU, a general-purpose GPU board, a volatile memory device such as a dynamic random access memory, and a non-volatile memory device such as a solid-state drive. The server connects to an external communication network through a network interface card supporting packet-based communication. The server executes software components including an operating system such as a general-purpose server operating system, a web server program, an application server framework such as an event-driven runtime framework, and a database management system such as a relational database engine. The server further executes a generative AI model runtime, for example a transformer-based neural network framework, that provides tensor computation primitives, automatic differentiation, and GPU offloading.

The terminal uses a user-operated computing device such as a smartphone, a tablet, or a personal computer. The terminal includes a processor, a memory, a display unit, an input device such as a touch panel, microphone, or keyboard, and a wireless or wired communication interface. The terminal executes an application program or a web browser program that communicates with the server via a secure communication protocol such as HTTPS.

The user operates the terminal to input outing-related information and to view and modify the generated outing plan.

### B. Program Structure and Data Structures

The server stores a program that logically includes a prompt handling module, a generative planning module, an external service orchestration module, an emotion analysis module, and an integration and delivery module.

The server maintains data structures such as:
a user profile structure including user identifier, preference information, and historical behavior information;
an outing plan structure represented as nested records of days, segments, and attributes (date, time range, location identifier, activity type, estimated cost, route identifier, reservation identifier, weather tag, congestion tag, coupon identifier, region-specific item tag, and emotion-based adjustment score);
a prompt context structure including a prompt sentence, auxiliary constraints, and schema specifications for the generative AI model;
a reservation record structure including reservation identification information, service provider identifier, time range, and payment related attributes;
an external information cache structure that stores results fetched from weather services, route search services, congestion information services, coupon services, and regional information databases, keyed by location and time.

The server represents each outing plan as structured data rather than a flat list of textual recommendations. The server stores each outing segment as a record with fixed-length fields and pre-defined enumerations for activity type and usage type. This specific structuring enables the server to perform efficient indexing, join operations, and update propagation when adjusting the plan based on external data or emotion analysis.

### C. Generative AI Model Configuration

The server uses a generative AI model implemented as a multi-layer transformer neural network. The generative AI model includes an embedding layer that converts tokens of the prompt sentence into fixed-dimension vectors, a plurality of self-attention layers that compute contextualized representations of tokens via scaled dot-product attention, and a feed-forward layer that maps hidden representations to output token distributions. The generative AI model uses positional encoding to represent token positions, layer normalization, and residual connections to stabilize training and inference.

The server configures the generative AI model with parameters representing weights of the attention and feed-forward layers. The server trains or fine-tunes the generative AI model offline using supervised learning on a corpus of historical itineraries, structured outing plans, and corresponding natural language descriptions. During training, the server uses a loss function such as cross-entropy between predicted tokens and ground-truth tokens, and updates the weights by a gradient-based optimization method such as stochastic gradient descent with adaptive learning rate. The server optionally applies data augmentation by randomly masking portions of itineraries, perturbing dates and costs, and injecting synthetic constraints to make the model robust to varied prompt sentences. The server defines specific output constraints for the generative AI model by embedding schema instructions in the prompt context structure. The server instructs the model to output a plan in a predefined pseudo-structured text format with markers indicating dates, time slots, location names, activity types, and costs. The server then parses the model output into the outing plan structure. By constraining the output in this way, the server reduces parsing ambiguity and lowers error rates in field extraction, which leads to more efficient downstream processing.

### D. Generation and Use of Prompt Sentences

The terminal presents an input interface in which the user enters outing preferences. The user inputs a free-form description such as:

“Create a 2-day weekend travel plan in Tokyo within a budget of 50,000 yen, focusing on local food, sightseeing, and shopping, and avoiding crowded places as much as possible. It should be suitable for children.”

The terminal converts user selections (destination, dates, budget, interests, constraints) into a coherent natural language prompt sentence. The terminal may generate a prompt sentence such as: “You are a travel planner. Based on the following user intent, create a 2-day weekend outing plan. Destination: Tokyo. Dates: Mar. 14 to Mar. 15, 2026. Budget: 50,000 yen including hotel and local transportation. Interests: local food, sightseeing, shopping. Constraints: avoid crowded areas and make it family friendly. Output the plan with days, times, place names, short descriptions, and estimated costs.”

The server receives this prompt sentence and constructs an internal prompt context by adding system instructions, schema definitions, and, where available, user historical behavior information. For example, if the user has previously preferred museum visits and early check-ins, the server appends explanatory lines stating that the user prefers earlier visiting hours and cultural facilities.

The server uses this enriched prompt sentence as a unified control input not only for itinerary generation but also for guiding how external services are later orchestrated. For example, the server stores references to budget constraints and preferred activity types in the outing plan structure so that reservation selection and coupon filtering logic can directly read these constraints from structured fields rather than re-parsing natural language text.

### E. Technical Processing and Improvements

The server processes data using specific algorithms that improve computer operation and are not mere automation of human mental steps. The server uses the outing plan structure as a central, normalized representation that is shared across modules. Because each segment includes explicit identifiers for times, locations, and external resource links, the server avoids repeated conversion between textual forms and structured forms when invoking external services.

The server performs route optimization by invoking a route search processing apparatus and then combining its output with congestion degree information. The server stores each route as a graph representation with nodes representing locations and edges representing transport segments, each edge annotated with estimated time and congestion metrics. The server uses a modified shortest-path algorithm that includes congestion degree as a cost term. The server searches for routes that minimize a weighted cost function combining travel time and congestion. By performing this computation on structured route graphs, the server reduces the number of external route queries needed when conditions change. Only portions of the graph that violate congestion thresholds are recomputed, while unaffected segments are reused from cache.

The server uses the generative AI model to generate an initial plan that is already aligned with the structure used internally. This reduces the need for multiple heuristic post-processing passes. Instead of a traditional rule-based planning engine that applies a large number of separate heuristics to map user input to activities, the generative AI model uses multi-head attention to directly map the prompt sentence and embedded historical behavior information to a nearly complete itinerary. Consequently, the number of intermediate objects and buffer copies in memory is reduced, which leads to lower memory bandwidth usage and improved throughput.

The emotion analysis unit uses signals from sensors or input devices, such as typing speed, interaction frequency, or explicit mood selections, to compute numerical emotion vectors. The server represents each emotion state as a fixed-dimension vector where each dimension corresponds to attributes such as stress level, excitement, or fatigue. The server uses a trained classifier neural network that maps sensor features and interaction patterns to these emotion vectors. The classifier uses a loss function measuring the difference between predicted labels and self-reported emotion states, and is trained with supervised learning.

The emotion engine then uses these emotion vectors as additional features when adjusting the outing plan. For example, if fatigue level is high, the emotion engine increases weights on features such as “short walking distance” and “more rest segments” when recalculating the cost of each activity segment. The server assigns each segment a suitability score computed as a function of predicted enjoyment, travel distance, time of day, and emotion features. The server then reorders or replaces segments to maximize total suitability subject to budget and time constraints. This multi-criteria optimization is executed by the processor using numerical optimization algorithms, and is not a simple sequential script that a human dispatcher could perform efficiently.

Because the server integrates emotion information into the core plan data structure, adjustments can be propagated to all dependent data in a controlled manner. When a segment is moved or replaced, the server automatically updates linked reservations, routes, weather annotations, and coupons by following references in the outing plan structure. This reduces inconsistent states and the need for repeated full-plan recomputation, thereby improving stability and speed.

### F. Interaction with External Services and Reduction of Communication Load

The server communicates with multiple external information sources. The server batches calls where possible by grouping requests based on location and time windows derived from the outing plan. When multiple segments fall in the same city and date range, the server issues a single weather query covering all required times, and then maps returned forecast entries onto individual segments. Likewise, the server requests route information and congestion information in aggregated form, rather than performing a separate query per segment.

The server caches responses in the external information cache structure with keys including location, date interval, and service type. When the user or the emotion engine makes local modifications to the plan, the server first consults the cache before issuing new network calls. This strategy reduces communication load, decreases latency, and enhances responsiveness, especially when many users are simultaneously adjusting their plans.

The server benefits from a clear separation between the generative AI planning stage and the external data enrichment stages, yet all stages share the same outing plan structure. This common data representation and caching strategy produces a technical effect: fewer data conversions, fewer extraneous network queries, and more reuse of intermediate results, which collectively improve processing efficiency.

### G. Example Scenario

The user operates the terminal and inputs a request:

“Create a weekend travel plan in a major city for my family of four. We want to enjoy local food and popular sightseeing spots, but please avoid rush-hour congestion as much as possible. Our budget is 50,000 yen in total.”

The terminal formulates a prompt sentence incorporating the user's selections and sends it to the server. The server generates an internal prompt context and provides it to the generative AI model. The model, using its multi-layer transformer architecture, outputs a two-day plan indicating visits to several districts, with morning and afternoon time slots, restaurant suggestions, and estimated expenses.

The server parses the output into the outing plan structure. The server then queries an external reservation processing apparatus to find and book a lodging service for the specified dates, obtaining reservation identification information. The server queries a weather information service to obtain forecasts for the weekend. The server queries a route search apparatus and a congestion information provider to determine low-congestion transit routes between the hotel and planned destinations. The server adjusts route segments where congestion exceeds a threshold and updates the outing plan. The server also queries a coupon service and a regional information database to retrieve available benefits and region-specific items, and associates them with dining and shopping segments. The emotion analysis unit detects, for example, that the user tends to reduce activity intensity on the second day based on previous interaction patterns, and the emotion engine slightly reduces the number of scheduled activities in the afternoon, automatically recalculating time allocations and ensuring budget constraints remain satisfied.

The terminal receives the integrated behavioral plan data and displays a structured view: days, time slots, locations, travel routes, weather icons, coupon badges, and recommended local products. The user can adjust a preference, such as requesting “less walking on the first day,” and the terminal sends a new prompt sentence. The server uses the same structured data and core modules to update only affected segments, without recomputing unrelated parts, which further demonstrates improved computational efficiency.

### H. Alternative Embodiments and Variations

The server may deploy the generative AI model on a separate dedicated inference server with a GPU cluster, in which case the main server communicates with the inference server via an internal network. The same outing plan structure and prompt context structures are used, and the advantages of reduced parsing and post-processing remain.

The server may use different neural network architectures, such as a sequence-to-sequence recurrent neural network or a hybrid model combining a transformer encoder and a graph neural network for route reasoning. In each case, the server maintains the design in which the model outputs a structured itinerary description with schema-like markers that are directly mapped into the outing plan structure.

The server may use different optimization strategies for emotion-based adjustment, including linear programming, heuristic search, or reinforcement learning that learns policies for changing segment order and content based on prior user feedback. In each variation, the system relies on numerical computation over structured representations rather than ad-hoc script-based rule systems, which produces the same general technical benefits of efficiency and consistency.

The terminal may present various user interfaces, such as a timeline view, a map-centric view, or a card-based view, but in every case, the terminal uses the same integrated behavioral plan data structure received from the server, minimizing client-side transformation overhead.

Through these embodiments and variations, the system provides a concrete technical implementation in which the server, terminal, and generative AI model cooperate to construct, store, and maintain a structured, multi-source outing plan. This configuration improves the functioning of the computer system itself by optimizing data structures, model usage, external service orchestration, and dynamic adjustment mechanisms, resulting in improved processing speed, accuracy of plan generation, consistency of data management, and reduction of communication and computation overhead.

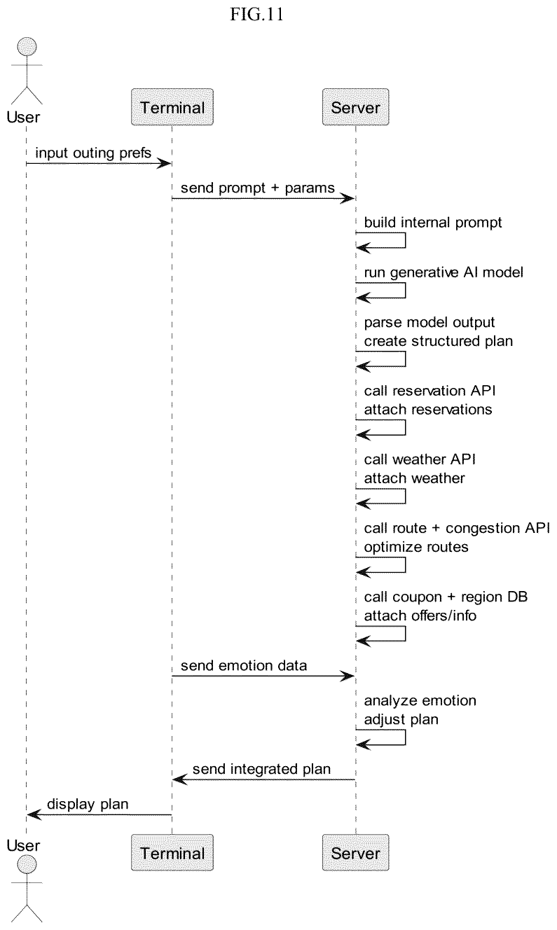

The following describes the processing flow using FIG. 11.

### Step 1:

The user operates the terminal to input outing preferences.

The user enters, via a graphical user interface on the terminal, information such as destination, dates, budget, number of travelers, interests, and constraints (for example, “avoid crowded places” or “family friendly”).

Input: raw user keystrokes and touch events on input fields.

Output: a set of structured preference values stored in the terminal's working memory (for example, destination string, start date, end date, numeric budget, list of interest keywords, list of constraint keywords).

### Step 2:

The terminal generates a natural language prompt sentence.

The terminal converts the structured preference values into a coherent text string suitable for a generative AI model, such as: “You are a travel planner. Based on the following user intent, create a 2-day weekend outing plan. Destination: a major city. Dates: Mar. 14 to Mar. 15, 2026. Budget: 50,000 yen . . . ”

Input: structured preference values from Step 1.

Processing: the terminal performs string concatenation and template filling, maps internal codes (for example, interest identifiers) to natural language phrases, and ensures grammatical formatting of the text.

Output: a natural language prompt sentence stored as a character string in the terminal's memory.

### Step 3:

The terminal transmits the prompt sentence and metadata to the server.

The terminal creates a request payload that includes the prompt sentence, structured parameters (destination, dates, budget, interests, constraints), and a user identifier, then sends it to the server over a communication network using an HTTPS POST request.

Input: prompt sentence string and structured parameters from Step 2.

Processing: the terminal serializes data into a network message, encrypts the message using a transport-level security protocol, and addresses it to an endpoint URL of the server.

Output: a network packet stream carrying the prompt sentence and associated data to the server.

### Step 4:

The server receives and parses the request from the terminal.

The server accepts the HTTPS request, authenticates the user if required, and extracts the JSON payload or other structured message body containing the prompt sentence and preference values.

Input: encrypted network packets from Step 3.

Processing: the server performs decryption, HTTP header parsing, payload extraction, and JSON decoding to reconstruct the original structured parameters and prompt sentence.

Output: an internal request object containing the user identifier, prompt sentence, and normalized preference values.

### Step 5:

The server constructs an internal prompt context for the generative AI model.

The server reads the prompt sentence and augments it with system-level instructions, schema descriptions, and user history context fetched from a database. The server assembles an internal prompt that specifies required output elements (for example, day labels, time slots, place names, activity types, estimated costs).

Input: internal request object from Step 4 and user profile data from persistent storage.

Processing: the server performs database queries to fetch historical behavior information and preferences, performs string concatenation and insertion of examples, and constructs a single internal prompt string or a sequence of text segments suitable for the generative AI model interface.

Output: an internal prompt context containing the enriched prompt sentence, model parameters, and output schema instructions.

### Step 6:

The server invokes the generative AI model to generate a base outing plan.

The server submits the internal prompt context to the generative AI model runtime, which executes on a processor and optionally on a GPU. The generative AI model computes token embeddings, attention weights, and output token probabilities to generate a textual description of a multi-day itinerary.

Input: internal prompt context from Step 5.

Processing: the server transfers the prompt tokens to the model, the model performs matrix multiplications and attention operations across multiple layers to infer the next tokens repeatedly, and the server collects the generated token sequence until an end condition is reached.

Output: a model output string representing the base outing plan in a pseudo-structured textual format.

### Step 7:

The server parses the model output into a structured outing plan.

The server converts the pseudo-structured textual plan into the internal outing plan data structure consisting of days, segments, and attributes.

Input: model output string from Step 6.

Processing: the server applies pattern matching, delimiter detection, and field extraction algorithms to identify dates, time ranges, location names, descriptions, estimated costs, and activity types. The server validates values (for example, checks date formats, numeric ranges, and total cost constraints) and maps textual location names to internal location identifiers via a geocoding or lookup function.

Output: an initial structured outing plan object stored in server memory.

### Step 8:

The server identifies reservation requirements within the outing plan.

The server scans the structured outing plan to locate segments corresponding to accommodation or long-distance transportation that may require reservations.

Input: structured outing plan from Step 7.

Processing: the server evaluates each segment's activity type and duration, applies rules to classify segments as “lodging,” “inter-city travel,” or “ticketed attraction,” and constructs a list of reservation request items with times, locations, and service types.

Output: a reservation request list containing one or more reservation request records.

### Step 9:

The server communicates with an external reservation processing apparatus.

The server sends search queries to reservation systems to obtain available service options and, when instructed by system logic or user preference, confirms specific reservations.

Input: reservation request list from Step 8.

Processing: the server serializes each reservation request into an API call, applies filters such as budget limits and proximity to planned locations, and, upon receiving candidate service information, executes selection algorithms (for example, sorting by price and rating) to choose an optimal service.

The server then sends a reservation confirmation request and receives reservation identification information.

Output: confirmed reservation records each containing reservation identification information, service details, and linkage to corresponding outing plan segments.

### Step 10:

The server attaches reservation information to the outing plan.

The server updates relevant segments in the outing plan with reservation identifiers and related attributes.

Input: structured outing plan from Step 7 and confirmed reservation records from Step 9.

Processing: the server locates segments matching the date, time, and location specified in each reservation record, inserts reservation identifiers into these segments, and updates status fields to indicate “confirmed.”

Output: an outing plan enriched with reservation information.

### Step 11:

The server acquires weather information for the outing plan.

The server queries an external weather information source for each location and date range in the outing plan.

Input: enriched outing plan from Step 10.

Processing: the server extracts unique combinations of locations and dates, composes batch requests to the weather service, and receives forecast datasets. The server maps forecast entries to specific segments based on time alignment and geographic region.

Output: an outing plan with weather attributes (such as expected condition and precipitation probability) associated with relevant segments.

### Step 12:

The server calculates movement routes and retrieves congestion data.

The server sends requests to a route search processing apparatus to obtain routes between consecutive locations in the outing plan, then queries a congestion information provider for congestion degree along these routes.

Input: outing plan with time-ordered locations from Step 11.

Processing: the server builds origin-destination pairs from consecutive segments, generates route search queries that specify desired departure times and transport modes, and receives route candidates including travel time and intermediate stops. The server then sends route identifiers and time windows to a congestion service and receives congestion degree information per route segment.

Output: movement route information annotated with congestion degree values, and a mapping between outing plan segments and one or more route variants.

### Step 13:

The server optimizes routes based on congestion thresholds.

The server evaluates congestion degree for each candidate route and selects or recalculates routes to avoid high congestion.

Input: movement route information and congestion degree data from Step 12.

Processing: the server compares congestion values against a predetermined threshold, computes a cost metric that combines travel time and congestion, and runs a path selection algorithm to choose the route with minimum cost. For routes exceeding the threshold, the server requests alternative routes from the route search apparatus, recomputes the cost metric, and selects less congested routes.

Output: updated route selections for each movement segment and an outing plan with congestion-aware route associations.

### Step 14:

The server acquires discount and benefit information.

The server communicates with an external benefit information providing apparatus to obtain discount or benefit offers applicable to locations, time ranges, and usage types appearing in the outing plan.

Input: outing plan with segments including location, time, and activity type from Step 13.

Processing: the server transforms segment attributes into query parameters, issues batched API requests to coupon and promotion services, and receives lists of available offers with conditions and identifiers. The server filters offers by validity period, geographical coverage, and user constraints such as budget or preferences, and matches offers to specific segments.

Output: an outing plan that includes references to applicable discount or benefit information for relevant segments.

### Step 15:

The server acquires region-specific item and tourism resource information.

The server queries a regional information database to fetch region-specific items and tourism resources associated with regions present in the outing plan.

Input: outing plan with region identifiers inferred from locations from Step 14.

Processing: the server aggregates distinct region identifiers, performs database lookups to retrieve lists of local products, souvenirs, and tourist attractions, and selects entries appropriate to the type of segment (for example, shopping or free time). The server attaches identifiers or descriptive tags for these items to corresponding segments.

Output: an outing plan enriched with region-specific item information and tourism resource information.

### Step 16:

The server analyzes user emotion and adjusts the outing plan.

The server receives emotion-related signals from the terminal, such as explicit feedback inputs or interaction patterns, and processes them in an emotion analysis unit to infer an emotion state. The server then applies an emotion engine to adjust the outing plan.

Input: outing plan from Step 15 and emotion-related sensor or input data transmitted from the terminal.

Processing: the server extracts features from emotion-related data (for example, frequency of plan modification, speed of navigation, or self-reported mood labels), feeds these features into a trained classifier or regression model to obtain emotion vectors, and computes adjustment scores for segments based on compatibility with the emotion state. The server may lengthen rest periods, reduce walking distances, or reorder activities by applying optimization logic that maximizes an overall suitability score subject to time and budget constraints.

Output: an emotion-adjusted outing plan in which segment order, durations, or activity types have been modified in response to emotion information.

### Step 17:

The server generates integrated behavioral plan data for delivery.

The server compiles all associated data-reservations, weather, routes, congestion metrics, discounts, region-specific items, and emotion-based adjustments-into a single integrated behavioral plan data structure.

Input: emotion-adjusted outing plan from Step 16 and linked external data records stored during previous steps.

Processing: the server traverses the outing plan segments, retrieves linked records using identifiers, and constructs a nested representation that includes all attributes required by the terminal UI. The server may compress or serialize this structure into a compact format and attach metadata such as version numbers or timestamps.

Output: integrated behavioral plan data ready for transmission to the terminal.

### Step 18:

The server sends the integrated behavioral plan data to the terminal.

The server packages the integrated behavioral plan data into a response message and transmits it over the communication network.

Input: integrated behavioral plan data from Step 17.

Processing: the server serializes the data structure into a response format, sets appropriate headers and status codes, encrypts the response, and sends it via an HTTPS response to the terminal's network address.

Output: encrypted response packets arriving at the terminal, containing the integrated behavioral plan data.

### Step 19:

The terminal receives, parses, and displays the integrated behavioral plan data.

The terminal processes the response, reconstructs the integrated behavioral plan, and presents it to the user through a graphical interface.

Input: encrypted response packets from Step 18.

Processing: the terminal decrypts the packets, parses the serialized data into internal objects, and maps outing segments to UI elements such as timelines, maps, and lists. The terminal displays, for each segment, the time, location, activity description, route overview, weather icons, discount indicators, reservation status, and region-specific item suggestions.

Output: a visual representation of the integrated behavioral plan on the terminal display, enabling the user to view and interact with the generated outing plan.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional trip-planning and navigation systems primarily focus on static route calculation and simple point-of-interest listing. Such systems generally compute routes based on fixed map data and optionally traffic information, and separately provide weather information or facility search results. As a result, these systems suffer from several technical limitations in how information is processed and integrated within the computing environment.

First, conventional systems lack a unified computation pipeline that dynamically fuses heterogeneous data sources-such as map data, real-time environment information, and user behavior history-into a coherent, machine-processable representation. Existing systems typically retrieve route information from a mapping service, weather information from a weather service, and user preferences from a profile database, but handle these streams in a loosely coupled, ad-hoc manner. This results in fragmented processing, redundant API calls, and increased latency when updating an outing plan in response to changing conditions.

Second, conventional systems do not effectively leverage generative AI models as a programmable planning component within the routing and scheduling pipeline. While generative AI models can be used to generate textual recommendations, they are commonly treated as user-facing “chatbots” rather than as structured subroutines integrated into the trip-planning computation. As a consequence, the system fails to exploit generative AI models as a back-end planning engine that operates on explicit prompt sentences encoding route information, environment information, and user characteristic information, and that returns structured plan configuration data suitable for automatic downstream processing.

Third, conventional systems exhibit poor responsiveness and scalability when environmental conditions or congestion states change during an outing. When weather or congestion varies, existing systems often require the user to manually restart the search or re-enter query parameters, thereby causing duplicated computation and inconsistent state between the route engine, the recommendation engine, and the reservation engine. There is no standardized mechanism for generating updated prompt sentences that reflect changes in environment information and congestion indexes, and for automatically triggering re-planning by the generative AI model and synchronizing the updated plan with the user terminal.

Fourth, existing systems are typically not designed to generate and manage congestion-avoidance routes as a first-class computational object that is jointly considered with personalized recommendations. Conventional navigation engines may provide alternative routes with different estimated times, but they do not systematically estimate a congestion degree index that can be combined with user-specific congestion-avoidance tendencies and environment information, and then used as part of a programmatic planning process involving a generative AI model.

These limitations collectively degrade the computational efficiency, adaptability, and coherence of trip-planning systems. In particular, they hinder the ability of the system to (i) maintain a consistent internal representation across route, environment, preference, and reservation data; (ii) automatically regenerate outing plans with minimal user intervention; and (iii) provide machine-processable outputs from a generative AI model that can be directly integrated into routing and reservation logic.

Accordingly, there is a need for a computer-implemented technique that improves the functioning of a trip-planning server by introducing: (1) a structured generation of prompt sentences that encode route information, environment information, user characteristic information, and congestion-avoidance policies; (2) a tightly coupled integration of a generative AI model as a core planning component returning structured outing plan configuration information; and (3) a dynamic re-planning mechanism that monitors environment and congestion changes and automatically updates the outing plan while maintaining consistency across routing, recommendation, and reservation modules. Such a technique should reduce redundant computation, improve response time and planning quality under changing conditions, and provide a more robust and scalable planning framework at the system level.

The specific processing by the specific processing unit 290 of the data processing device 12 in Application Example 1 is realized by the following means.

The present invention provides a server comprising a processor configured to acquire departure position information and destination position information from a user terminal, calculate movement route information based on the departure position information and the destination position information, acquire environment information including weather information corresponding to the movement route information from an external information providing apparatus, associate the environment information with the movement route information, dynamically adjust the movement route information based on the environment information, acquire behavior history information and preference information from a user history information storage apparatus, analyze the behavior history information and the preference information to generate user characteristic information, generate a prompt sentence in a natural language as input information including at least the destination position information, the movement route information, the environment information, and the user characteristic information, instruct a generative AI model to generate an outing plan by using the prompt sentence, and generate outing plan information based on outing plan configuration information received from the generative AI model, coordinate with an external reservation processing apparatus based on stay candidate location information included in the outing plan information, transmit and receive reservation processing information related to facility use or movement means, generate reservation confirmation information, estimate a congestion degree index based on the movement route information and the environment information, calculate congestion-avoidance movement route information that avoids a high-congestion area or a high-congestion time zone based on the congestion degree index, integrate the outing plan information, the reservation confirmation information, and the congestion-avoidance movement route information to generate integrated display outing plan information to be presented to the user terminal, monitor changes in the environment information and in the congestion degree index at predetermined time intervals, when the changes satisfy a predetermined condition, update the prompt sentence to include information corresponding to the changes, instruct the generative AI model to regenerate the outing plan, and update the integrated display outing plan information based on regenerated outing plan information. This enables the server to operate as an improved trip-planning engine that programmatically encodes heterogeneous data into a structured prompt sentence, obtains machine-processable outing plan configuration information from the generative AI model, reduces redundant recomputation by automatically triggering re-planning upon environmental or congestion changes, maintains consistency between routing, recommendation, and reservation states, and thereby enhances overall computational efficiency, adaptability, and reliability of computer-implemented outing plan generation.

The term “user terminal” refers to an information processing device operated by a user, such as a portable communication device, a tablet device, a personal computer, or any other computing device capable of transmitting and receiving data to and from a server over a communication network.

The term “departure position information” refers to location information indicating a starting position of movement for a user, the location information including at least one of a geographic coordinate, a place name, an address, or an identifier associated with a location.

The term “destination position information” refers to location information indicating a target position of movement for a user, the location information including at least one of a geographic coordinate, a place name, an address, or an identifier associated with a location.

The term “movement route information” refers to data representing at least one candidate path between a departure position and a destination position, the data including information such as a sequence of waypoints, transportation modes, estimated travel times, distances, and transfer points.

The term “environment information” refers to data representing conditions in an area along or around a movement route, the data including at least weather information and optionally including traffic information, hazard information, or congestion information.

The term “weather information” refers to data indicating atmospheric conditions for a location and time period, the data including at least one of temperature, precipitation, wind, humidity, visibility, and weather alerts.

The term “external information providing apparatus” refers to a computing system or service, accessible via a communication network, that provides environment information, map information, congestion information, or other external data to the server.

The term “behavior history information” refers to data representing past actions of a user related to trips, visits, or content interactions, the data including at least visited locations, selected facilities, reservation records, rating records, or usage logs.

The term “preference information” refers to data representing a user's likes, dislikes, and tendencies with respect to categories such as facility types, activities, times of day, congestion tolerance, or transportation modes, the data being derived from explicit user input or inferred from behavior history information.

The term “user history information storage apparatus” refers to a storage system, such as a database system or a file storage system, that stores behavior history information, preference information, and other user-related data, and that is accessible by the server.

The term “user characteristic information” refers to processed data representing one or more attributes of a user, the attributes being derived from behavior history information and preference information and including, for example, category preferences, congestion-avoidance tendencies, and activity patterns.

The term “prompt sentence” refers to a text sequence expressed in a natural language, the text sequence encoding at least destination position information, movement route information, environment information, and user characteristic information, and being configured as input to a generative AI model to cause generation of an outing plan.

The term “generative AI model” refers to a machine-implemented information processing model, such as a statistical language model or neural network model, that generates output data including text or structured data in response to a prompt sentence that is input to the model.

The term “outing plan configuration information” refers to data output from the generative AI model that specifies components of an outing plan, the data including at least stay candidate location information, recommended visit time information, and activity descriptions in a structured or semi-structured format.

The term “outing plan information” refers to data representing a structured plan for user movement and activities, the data being generated on the basis of outing plan configuration information and including at least a schedule, locations to visit, and associated descriptive information.

The term “stay candidate location information” refers to data identifying locations that are candidates for user stay or visit in an outing plan, the data including at least a location identifier, a category, and optionally a recommended time period or descriptive information.

The term “external reservation processing apparatus” refers to a computing system or service that performs reservation processing for facilities, services, or transportation, the computing system being capable of receiving reservation requests and returning reservation responses through a communication network.

The term “reservation processing information” refers to data transmitted between the server and an external reservation processing apparatus, the data including at least a reservation request, reservation parameters, reservation response, or cancellation information.

The term “reservation confirmation information” refers to data indicating that a reservation has been successfully established, the data including at least a reservation identifier and associated reservation details such as time, place, and service conditions.

The term “congestion degree index” refers to a numerical or categorical value that represents a level of congestion for a route segment, area, or time period, the value being estimated on the basis of movement route information, environment information, or external congestion data.

The term “congestion-avoidance movement route information” refers to movement route information that has been calculated or modified to reduce exposure to high-congestion areas or high-congestion time periods based on the congestion degree index.

The term “integrated display outing plan information” refers to data generated by integrating outing plan information, reservation confirmation information, and congestion-avoidance movement route information, the data being formatted for presentation on a user terminal.

The term “preference category information” refers to data within the user characteristic information that indicates user preferences with respect to categories of facilities, activities, or locations, such as hot springs, museums, or shopping areas.

The term “congestion-avoidance tendency information” refers to data within the user characteristic information that indicates a user's tendency to avoid or tolerate congested places or times, the data being used as a factor in route and plan generation.

The term “structured data format” refers to a data representation format, such as a list or object structure, in which elements are organized according to predefined fields or keys that are machine-readable and suitable for programmatic processing.

The term “weather change information” refers to data indicating a change over time in weather information for a relevant location or time period, the data including, for example, the onset of precipitation, a change in temperature, or issuance of a weather alert.

The term “congestion status change information” refers to data indicating a change over time in congestion conditions reflected by the congestion degree index, such as an increase or decrease in congestion for a particular route segment or time period.

The term “outdoor activity candidate information” refers to data within an outing plan that represents candidate activities primarily conducted outdoors, such as visits to parks, viewpoints, or walking tours.

The term “indoor activity candidate information” refers to data within an outing plan that represents candidate activities primarily conducted indoors, such as visits to indoor facilities, museums, or indoor hot springs.

In one embodiment, a server implements the claimed system by executing a program on a hardware platform that includes at least a central processing unit (CPU), a main memory, a non-volatile storage device, and a network interface. The server runs an operating system such as a general-purpose server operating system, and executes an application program implemented, for example, using a high-level programming language. The server stores instructions and data structures in the main memory and the storage device, and exchanges data with a user terminal via the network interface over a packet-switched network.

A user operates the terminal, which can be, for example, a smartphone, a tablet device, or a personal computer, and the terminal executes an application or a web client. The terminal includes a display, an input interface such as a touch panel or keyboard, a local processor, and a communication module. The terminal transmits user input to the server and receives and displays outing plan information generated by the server.

The server implements multiple functional modules as software components. In one example, the server includes a route computation module, an environment information acquisition module, a user characteristic analysis module, a prompt generation module, a generative AI interface module, an outing plan synthesis module, a reservation coordination module, a congestion estimation module, an integration module, and a dynamic re-planning module. These modules interact through explicitly defined data structures stored in memory, such as route objects, environment objects, user profile objects, prompt objects, plan objects, reservation objects, and congestion index objects. The server uses a network-based map service as one implementation of an external information providing apparatus. The route computation module transmits location queries containing departure position information and destination position information to this map service via the network interface, and receives responses containing route candidates. The server stores each route candidate as a movement route information object including fields for a sequence of nodes (waypoints), transportation mode identifiers, estimated travel times, distances, and link identifiers associated with segments of a transportation network graph. The server can organize these fields in an adjacency-list or adjacency-matrix form to support further computational processing such as shortest-path optimization or congestion-adjusted path recalculation.

The server uses a network-based weather service as another implementation of the external information providing apparatus. The environment information acquisition module transmits queries that include geographic coordinates derived from the movement route information. The server receives weather information including timestamped records of temperature, precipitation, wind speed, and alert flags. The server stores environment information as a timeline structure, for example, a time-indexed array in which each element is associated with a route segment identifier and includes one or more weather feature values. The server associates environment information with movement route information by matching geographic and temporal attributes, and annotates each route segment with environment attributes such as predicted precipitation probability or weather severity scores.

The server stores behavior history information and preference information in a database that constitutes the user history information storage apparatus. The user characteristic analysis module retrieves records such as past visits, reservation history, and explicit ratings. The module converts these records into feature vectors for each user. For example, the server assigns numeric values to categories of activity (such as hot springs, museums, shopping, outdoor viewpoints, indoor facilities), time-of-day preferences, typical trip durations, and congestion tolerance. The server uses a vector representation in which each dimension corresponds to a category or behavioral attribute, and the value represents a frequency, a normalized probability, or a weighted score. The server analyzes this feature vector using an algorithm such as a feed-forward neural network or a clustering-based classifier. In one implementation, the neural network has an input layer corresponding to the feature dimensions, one or more hidden layers implementing rectified linear or similar activation functions, and an output layer that produces user characteristic information such as preference category information and congestion-avoidance tendency information. The server trains this neural network in advance using historical user data, a loss function such as cross-entropy or mean squared error, and an optimization method such as stochastic gradient descent with adaptive learning rates. During training, the server stores model parameters (weights and biases) in the storage device, and updates them by computing gradients of the loss function with respect to the parameters. The server can apply data augmentation techniques, such as randomly perturbing time-of-day or noise-adding to category frequencies, to increase generalization and robustness.

The server generates user characteristic information by applying the trained neural network to the user's feature vector. The output includes, for example, a probability distribution over activity categories and a congestion-avoidance score. The server then constructs a user characteristic object that includes preference category information (such as high preference for hot springs and scenic viewpoints) and congestion-avoidance tendency information (such as strong avoidance of high-congestion areas).

The server uses the prompt generation module to create a prompt sentence that encodes multiple types of data into a unified natural-language representation. The module receives as input the destination position information, movement route information, environment information, and user characteristic information. The module applies a deterministic formatting algorithm that converts structured data into a standardized template, thereby eliminating ambiguity for the generative AI model and improving reproducibility of the model's output.

In one example, the server generates the following prompt sentence:

“User's destination is Hakone. Departure is from Tokyo on 2026 Feb. 15 at 09:00 (JST). Based on past behavior logs, the user strongly prefers hot springs and scenic viewpoints, and tends to avoid crowded areas and large shopping malls. Weather forecasts predict rain in Hakone from 15:00 to 18:00, but the morning is expected to be clear. Please act as a travel planner. Propose a one-day trip plan that: 1) starts in Tokyo in the morning and arrives in Hakone before noon, 2) includes 2-3 recommended hot spring facilities in Hakone, 3) schedules outdoor scenic spots before the rain begins, 4) selects time slots and locations that are likely to be less crowded, 5) suggests 1-2 souvenir shops that match the user's preferences, and 6) outputs the result as a structured list with fields: name, category, recommended time, crowd level, description, and address.”

The server then transfers this prompt sentence to the generative AI interface module. The generative AI model in one embodiment is a sequence-to-sequence neural network model, such as a transformer architecture that uses self-attention mechanisms over multiple layers. The server stores the model as a set of learned parameters, including embedding matrices, multi-head attention parameters, feed-forward layer parameters, and layer normalization parameters. The server or an external computing service trains the model on large-scale corpora that include trip descriptions, schedule examples, and structured plan data.

The generative AI model processes the prompt sentence by converting each token into an embedding vector, applying multiple layers of self-attention and non-linear transformations, and computing a probability distribution of the next token at each decoding step. The server specifies hyperparameters such as the number of layers, the attention head count, and the dimensionality of embeddings, and defines an output format bias by appending explicit field labels in the prompt. During training, the server minimizes a loss function such as negative log-likelihood of the ground truth next token, and updates model weights using backpropagation and gradient-based optimization. The server can include regularization techniques such as dropout and weight decay to avoid overfitting. The server, during runtime, sends the prompt sentence through the generative AI interface module, which communicates with the generative AI model locally or via an external service. The model returns outing plan configuration information in a structured textual form, for example, a list of lines each containing a location name, category, recommended time interval, expected crowd level, and a short description. The server parses this output using a parsing module that recognizes field labels and delimiters, converts the textual representation into a machine-readable structure, and stores it as outing plan configuration information.

The server next uses the outing plan synthesis module to convert the outing plan configuration information into outing plan information. The server aligns the recommended times and locations with the movement route information and environment information. Specifically, the server checks whether recommended locations lie within a threshold distance from the existing route, using geographic distance calculations. If necessary, the server inserts additional waypoints and route segments to incorporate a recommended location, subject to constraints such as maximum detour time or user-specified limits.

The server uses the reservation coordination module to communicate with an external reservation processing apparatus. For each stay candidate location that supports reservations, the server generates reservation processing information including a facility identifier, desired start time, duration, and number of persons. The server transmits this information to the external apparatus and receives a response containing success or failure status, a reservation identifier, and any constraints. The server stores reservation confirmation information in a reservation object, which the integration module later merges into the integrated display outing plan information.

The server calculates a congestion degree index for each route segment using the congestion estimation module. In one embodiment, the server retrieves congestion-related data from the external information providing apparatus, such as historical or real-time traffic density, and transforms it into a normalized congestion value. The server optionally combines this value with estimated pedestrian density near sightseeing spots, using models trained on historical flow data. The server stores the congestion degree index as an array indexed by route segment and time, and then applies a cost function that combines travel time and congestion level. The server computes congestion-avoidance movement route information by running a modified shortest-path algorithm on a graph where each edge cost is weighted by both travel time and congestion index, and is further biased according to the user's congestion-avoidance tendency information. This non-standard weighting scheme causes the algorithm to favor less crowded, though not necessarily shortest, routes when the user strongly prefers congestion avoidance, thereby improving comfort while maintaining computational efficiency.

The server uses the integration module to generate integrated display outing plan information. The server merges the outing plan information, reservation confirmation information, and congestion-avoidance movement route information into a unified timetable and map-aligned representation. In an internal data structure, the server associates each visit event with a specific route segment, start time, end time, weather attributes, and reservation attributes. The server orders events temporally and geographically, and represents them as a time-indexed sequence suitable for rendering on a timeline or map view. The server transmits this integrated display outing plan information to the terminal.

The terminal receives the integrated display outing plan information, parses it, and presents it on the display. The terminal can show a map with route overlays, a list of scheduled activities, reservation details, and weather icons for each time period. The user can select an activity or reservation item to view more details, request a change, or cancel a reservation. The terminal transmits corresponding instructions back to the server, which updates reservation confirmation information and, if necessary, triggers partial re-planning.

The server uses the dynamic re-planning module to monitor changes in environment information and the congestion degree index. The module schedules periodic acquisition of updated environment information and congestion values. When the server detects that a change satisfies a predetermined condition, such as a change in predicted precipitation crossing a threshold or congestion exceeding a specified level, the server updates the prompt sentence. In this updated prompt, the server includes weather change information and congestion status change information, and explicitly asks the generative AI model to adjust activities. An example of such an updated prompt sentence is: “User's destination is still Hakone. The user is currently on the way from Tokyo. New weather information shows heavy rain and strong wind warnings from 13:00 onwards for the Hakone area. The user prefers hot springs and quiet indoor locations, and wants to avoid walking outside in the rain. Please revise the existing plan and propose an updated afternoon schedule that: 1) replaces outdoor scenic viewpoints with indoor hot spring or museum options, 2) minimizes walking time outdoors after 13:00, 3) keeps the total return time to Tokyo similar to the original plan, and 4) outputs the result as a list of activities with fields: name, category, start time, end time, indoor or outdoor, and description.”

The server again sends this prompt sentence to the generative AI model, receives revised outing plan configuration information, and updates the outing plan information and integrated display outing plan information accordingly. The server then notifies the terminal of the updated plan. By structuring data into explicit route objects, environment timelines, user characteristic vectors, congestion index arrays, and integrated plan structures, the server improves internal data management and reduces redundancy. The standardized prompt sentence format allows the generative AI model to act as a deterministic subcomponent that operates on a well-defined input space and returns machine-processable configuration data. This approach differs from simple automation of human planning because the server uses the generative AI model as a planning kernel that cooperates with algorithmic modules (such as graph-based route optimization and neural-network-based user profiling) through explicit interfaces and non-conventional data flows. The server achieves technical improvements in several respects. First, the server reduces processing time when updating outing plans under changing conditions, because only incremental changes in environment information and congestion indexes are encoded into updated prompt sentences, and the generative AI model is asked to revise only affected portions of the plan. Second, the server improves accuracy and relevance of route and activity recommendations by combining user characteristic information derived from a dedicated neural network with environment information and congestion-aware routing. Third, the server reduces communication load with external services by caching route segments, environment information, and model outputs, and by limiting re-queries to those segments or periods that have changed beyond thresholds. Fourth, the server increases robustness of plan execution by maintaining consistency between routing, recommendation, and reservation information in a single integrated plan object that is synchronized with the terminal. In another embodiment, the server can employ alternative machine learning architectures for user characteristic analysis, such as a gradient-boosted decision tree model or a factorization machine, and can vary the loss function and optimization method. The generative AI model can be implemented locally on the server or distributed across multiple computing nodes, and can be trained using different tokenization methods and attention mechanisms. The congestion estimation module can use additional sensor data, such as anonymized location traces, and the cost function can incorporate further factors like safety or accessibility. These variations still rely on the same core concept of generating a prompt sentence that encodes structured route, environment, user characteristic, and congestion information, and of using a generative AI model to produce structured outing plan configuration information that the server then integrates with algorithmic routing and reservation modules.

In yet another embodiment, the server can adapt to different domains, such as daily commuting or multi-day travel, by changing the time horizon, the level of route granularity, and the set of activity categories, without altering the fundamental architecture of prompt generation, generative AI integration, congestion-aware routing, and dynamic re-planning.

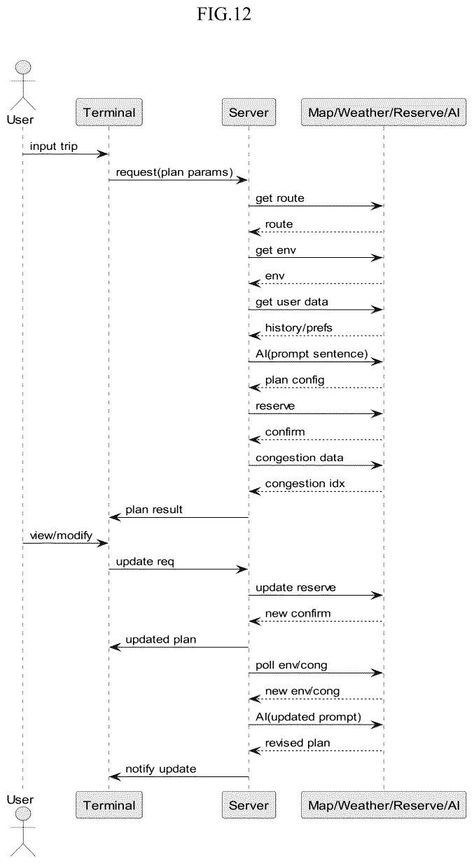

The following describes the processing flow using FIG. 12.

### Step 1:

User operates the terminal and inputs departure position information and destination position information, together with an optional desired departure time and basic preferences (for example, “avoid highways” or “prefer public transport”).

Terminal uses an input interface to capture this data, validates that required fields are present, and constructs a structured request object.

Input: raw user inputs (textual place names, time selections, simple preference flags).

Output: a structured request including user identifier, departure position information, destination position information, departure time, and basic preference flags.

### Step 2:

Terminal transmits the structured request to the server over a communication network using a predefined application protocol.

Terminal converts the request object into a serialized representation (for example, JSON over HTTPS) and sends it to a designated endpoint on the server.

Input: structured request from Step 1.

Output: a network message containing the structured request, delivered to the server.

### Step 3:

Server receives the network message from the terminal and performs initial parsing and validation.

Server decodes the serialized representation, checks that departure position information and destination position information are valid, confirms that the user identifier is recognized, and logs the request.

Input: network message from Step 2.

Output: an internal request object stored in server memory, including normalized departure and destination descriptors and validated user identifier.

### Step 4:

Server calls an external map service to convert departure and destination descriptors into geographic coordinates.

Server sends location queries containing textual addresses or place identifiers to the external information providing apparatus, receives coordinate responses, and creates movement route seed data.

Input: internal request object with departure position information and destination position information.

Output: coordinate data for departure and destination, stored as part of movement route information candidates.

### Step 5:

Server computes initial movement route information based on the acquired coordinates.

Server sends route queries (including coordinates, transportation mode, and departure time) to the map service, receives candidate routes, and selects one or more optimal routes using a cost function that may consider travel time and number of transfers.

Input: departure and destination coordinates from Step 4, user basic preferences from Step 1.

Output: movement route information including a sequence of segments, segment times, distances, and transportation modes.

### Step 6:

Server acquires environment information for the route from an external information providing apparatus that supplies weather and optional traffic data.

Server maps each route segment or waypoint to a geographic region and time interval, requests corresponding environment data, and annotates each segment of the movement route information with weather attributes and, when available, traffic or hazard values.

Input: movement route information from Step 5 (segment coordinates and time estimates).

Output: environment information timeline associated with route segments, including weather information for each relevant time and location along the route.

### Step 7:

Server retrieves behavior history information and preference information for the user from a user history information storage apparatus.

Server queries a database using the user identifier, reads past visit records, reservation logs, and explicit ratings, and constructs feature vectors that summarize category frequencies, time-of-day habits, and congestion tolerance indicators.

Input: user identifier from Step 3.

Output: behavior history information and preference information transformed into numerical feature vectors.

### Step 8:

Server analyzes the feature vectors to generate user characteristic information.

Server feeds the feature vectors into a trained machine learning model (for example, a neural network) that computes probability scores for activity categories and a congestion-avoidance tendency score, then post-processes these scores into discrete labels and numerical indicators.

Input: feature vectors from Step 7.

Output: user characteristic information including preference category information and congestion-avoidance tendency information.

### Step 9:

Server constructs a prompt sentence in natural language that encodes destination position information, movement route information, environment information, and user characteristic information.

Server converts structured route data (arrival times, key waypoints), weather forecasts (expected rain periods, alerts), and user preferences into text segments and inserts them into a predetermined prompt template, ensuring that output format requirements are clearly specified.

Input: destination position information from Step 3, movement route information from Step 5, environment information from Step 6, user characteristic information from Step 8.

Output: a prompt sentence string suitable as input to a generative AI model.

### Step 10:

Server sends the prompt sentence to the generative AI model via a generative AI interface module and receives outing plan configuration information.

Server forwards the prompt sentence to the model, sets model parameters such as temperature and maximum output length, waits for the model to generate a response, and then captures the response text.

Input: prompt sentence from Step 9.

Output: a generated text describing an outing plan, containing stay candidate location information, recommended times, and descriptions in a semi-structured form.

### Step 11:

Server parses the generated text into machine-readable outing plan configuration information.

Server scans the text for field labels (such as name, category, recommended time, crowd level, description, address), extracts tokens for each field, and builds a list of structured records representing candidate activities.

Input: generated text from Step 10.

Output: outing plan configuration information as a structured list or array of candidate activities with fields populated.

### Step 12:

Server synthesizes outing plan information by aligning the outing plan configuration information with the movement route information and environment information.

Server determines where each stay candidate location lies relative to the existing route, computes travel times to insert additional stops if needed, adjusts recommended times to avoid overlapping events, and discards or de-prioritizes candidates that would significantly exceed time or distance constraints.

Input: outing plan configuration information from Step 11, movement route information from Step 5, environment information from Step 6.

Output: outing plan information comprising a feasible timeline of activities, each associated with a specific time window, route segment, and environment context.

### Step 13:

Server coordinates with an external reservation processing apparatus to establish reservations for selected stay candidate locations in the outing plan information.

Server identifies locations that support reservation, prepares reservation processing information including facility identifiers and requested time intervals, sends reservation requests, and interprets responses to determine success or failure.

Input: outing plan information from Step 12, external reservation capabilities obtained from configuration or external service queries.

Output: reservation confirmation information for each successfully reserved activity, and updated outing plan information reflecting reservation states.

### Step 14:

Server estimates a congestion degree index for relevant route segments and time periods, using environment information, external congestion data, and user congestion-avoidance tendency information.

Server aggregates traffic density values, pedestrian flow estimates, and time-dependent factors into normalized congestion scores, and stores these scores in an index keyed by segment and time.

Input: movement route information from Step 5, environment information from Step 6, and optionally external congestion data.

Output: congestion degree index values for route segments and time windows.

### Step 15:

Server computes congestion-avoidance movement route information using the congestion degree index and user congestion-avoidance tendency information.

Server assigns a cost to each route segment that fuses travel time with congestion score, amplifies or attenuates congestion cost based on the user's tendency, and runs a path search algorithm on the route graph to obtain a route that minimizes the combined cost function.

Input: congestion degree index from Step 14, movement route information from Step 5, congestion-avoidance tendency information from Step 8.

Output: congestion-avoidance movement route information that may differ from the initial route in segment selection or timing.

### Step 16:

Server generates integrated display outing plan information by merging outing plan information, reservation confirmation information, and congestion-avoidance movement route information into a single coherent structure.

Server assigns each activity to a specific position in time and space on the updated route, attaches reservation identifiers and status flags, attaches weather and congestion annotations, and orders all elements chronologically for presentation.

Input: outing plan information from Step 12, reservation confirmation information from Step 13, congestion-avoidance movement route information from Step 15.

Output: integrated display outing plan information ready to be sent to the terminal.

### Step 17:

Server transmits the integrated display outing plan information to the terminal over the communication network.

Server serializes the integrated structure into a response message, applies any necessary compression or encoding, and sends the message to the terminal endpoint that issued the original request.

Input: integrated display outing plan information from Step 16.

Output: a network response message containing the integrated display outing plan information.

### Step 18:

Terminal receives the integrated display outing plan information and renders it for the user.

Terminal parses the received data, constructs visual elements such as map overlays, lists of activities, and reservation details, and displays these elements on the screen in an interactive form that allows selection and modification.

Input: network response message from Step 17.

Output: a graphical user interface presenting a complete outing plan to the user.

### Step 19:

User reviews the displayed outing plan and optionally requests changes, such as adding or removing activities, changing time windows, or canceling reservations.

Terminal captures these user operations as modification requests and bundles them into structured messages.

Input: user interactions with the displayed outing plan.

Output: modification request messages specifying changes to activities, times, or reservations.

### Step 20:

Terminal transmits the modification request messages to the server, and the server updates outing plan information and reservation confirmation information accordingly.

Server applies the requested changes, performs consistency checks on timing and route feasibility, updates or cancels reservations via the external reservation processing apparatus if needed, and regenerates a revised integrated display outing plan information object.

Input: modification request messages from Step 19, current outing plan information and reservation confirmation information from earlier steps.

Output: updated outing plan information, updated reservation confirmation information, and a revised integrated display outing plan information object.

### Step 21:

Server periodically monitors environment information and congestion degree index changes and determines whether dynamic re-planning is necessary.

Server sets timers or scheduled tasks to fetch updated weather and congestion data, compares new values to previous values using thresholds, and flags cases where significant changes occur during the outing time window.

Input: previously stored environment information and congestion degree index, newly acquired environment information and congestion data.

Output: a decision indicator specifying whether dynamic re-planning is required and, if so, which time periods and activities are affected.

### Step 22:

Server generates an updated prompt sentence that reflects environment changes and congestion status changes and requests a revised plan from the generative AI model.

Server extracts only the affected part of the schedule, encodes updated weather change information and congestion status change information into textual clauses, and modifies the previous prompt sentence to instruct the model to adjust specific segments (for example, replace outdoor activities after a certain time with indoor activities).

Input: original prompt sentence from Step 9, environment changes and congestion status changes from Step 21, current outing plan information.

Output: an updated prompt sentence that focuses on revising impacted portions of the outing plan.

### Step 23:

Server sends the updated prompt sentence to the generative AI model and updates the outing plan information and integrated display outing plan information based on the newly received outing plan configuration information.

Server obtains revised activity suggestions, parses them into structured data, re-aligns them with the current route and reservation constraints, recomputes any necessary congestion-avoidance routes for updated segments, and merges the results into the existing plan structure without altering unaffected portions.

Input: updated prompt sentence from Step 22, current movement route information, reservation confirmation information, and congestion degree index.

Output: updated outing plan information and a further revised integrated display outing plan information object reflecting environment-aware and congestion-aware changes.

### Step 24:

Server notifies the terminal of the updated integrated display outing plan information, and the terminal refreshes the user interface accordingly.

Terminal receives the updated data, compares it with the previous plan to highlight changes, and updates map routes, activity lists, and reservation details so that the user can follow the revised plan.

Input: updated integrated display outing plan information from Step 23.

Output: an updated graphical user interface reflecting dynamic re-planning results for the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel and outing planning systems rely on fragmented and static processing pipelines in which user preferences, reservation processing, environmental information, and navigation are handled by separate modules with limited interoperability. In such architectures, user condition information is typically converted into fixed-form search parameters rather than expressive prompt sentences suitable for processing by a generative AI model. As a result, plan generation often produces generic itineraries that are not sufficiently tailored to a user's detailed constraints and changing context. Furthermore, conventional systems generally perform reservation processing, weather retrieval, discount retrieval, and route calculation as independent tasks, without a unified control flow that maintains coherence between the generated plan and subsequent external information updates.

In addition, many existing systems do not treat user emotion or state information as a first-class input to the planning pipeline. Emotion, when considered at all, is often processed only as a display-side feature and is not integrated into the computational core that generates or updates the plan. Consequently, the system cannot dynamically change the plan in response to the user's satisfaction, stress, or fatigue inferred from sensors or input devices, leading to rigid user experiences. Moreover, conventional navigation cooperation is normally limited to passing destination coordinates to a navigation application, without incorporating real-time congestion information into the initial route computation or back into the overall plan. Route calculations are therefore often suboptimal with respect to congestion avoidance, and the planning system cannot automatically reflect congestion-aware results in subsequent plan revisions or alternative proposals.

These limitations manifest as inefficiencies and technical drawbacks in computer processing itself. The server-side processor executes multiple independent API calls and post-processing routines, but lacks a unified orchestration that takes as input a single, rich prompt sentence, uses a generative AI model to create a structured outing plan, and then systematically refines that plan using reservation systems, weather systems, discount and product information systems, traffic information systems, and navigation systems. Without such orchestration, redundant network requests, duplicated parsing logic, and inconsistent data states arise, increasing computation load and latency on the processor and information communication network.

Accordingly, there is a need for an improved computer-implemented system and server architecture that (i) transforms user condition information into a prompt sentence suitable for a generative AI model, (ii) generates outing plan information in a structured manner, (iii) coordinates with multiple external information processing systems for reservations, environmental data, and route guidance, (iv) integrates real-time congestion information into route calculation and plan updates, and (v) dynamically changes the plan based on user emotion information. By addressing these issues at the level of processor configuration and inter-system communication, the invention aims to improve the efficiency, adaptability, and technical performance of the overall information processing system.

The specific processing by the specific processing unit 290 of the data processing device 12 in Example 2 is realized by the following means.

The present invention provides a server comprising a processor configured to receive, through an information input unit, condition information relating to an outing that is input by a user via an information processing apparatus; to generate, based on the condition information, a prompt sentence including the condition information and intention of the user; to input the prompt sentence to a generative information processing model and obtain outing plan information as a structured output from the generative information processing model; to present, to the user, candidate information for an accommodation facility or a movement means included in the outing plan information; to call, via an information communication network, a reservation processing information processing system, to transmit reservation information relating to the accommodation facility or the movement means based on a selection result by the user, and to confirm a reservation; to call, via the information communication network, a weather information providing information processing system based on a scheduled visit region and schedule information included in the outing plan information, and to associate weather information corresponding to the scheduled visit region with the outing plan information; to call, via the information communication network, a route guidance information processing system based on movement section information included in the outing plan information, to acquire movement routes and candidate movement means for a movement section, and to propose a movement means according to a condition of the user relating to movement; to call, via the information communication network, at least one of a discount information providing information processing system and a product information providing information processing system based on a scheduled visit point or time period included in the outing plan information, and to associate discount information or product information related to the scheduled visit point with the outing plan information; to call, via the information communication network, a traffic information providing information processing system based on the movement section information, to acquire traffic information including a degree of congestion, and to calculate a route that avoids congestion and reflect the calculated route in a route request to the route guidance information processing system; and to estimate emotion information based on state information of the user acquired from a sensor or an input device, and to dynamically change the outing plan information in accordance with the emotion information. This enables the processor to orchestrate plan generation, reservation processing, environmental information integration, congestion-aware route calculation, and emotion-based dynamic adjustment within a unified computational framework, thereby reducing redundant processing, improving consistency and responsiveness of plan updates, and enhancing overall efficiency and technical performance of the computer-implemented outing planning system.

The term “processor” refers to a hardware or virtual processing element, such as a central processing unit, graphics processing unit, or logical processing core, configured to execute instructions that implement the functions of the system.

The term “information input unit” refers to a hardware or software component that acquires condition information relating to an outing from a user, via an information processing apparatus, through interfaces such as touch screens, keyboards, pointing devices, microphones, or communication interfaces.

The term “condition information” refers to data representing at least one constraint or preference of a user relating to an outing, including but not limited to destination, schedule, budget, number of participants, desired activities, movement preferences, and accommodation preferences.

The term “information processing apparatus” refers to an electronic device capable of executing an information processing program, including but not limited to a portable terminal, a stationary terminal, or a network-connected computing apparatus operated by a user.

The term “prompt sentence” refers to a piece of text or structured textual data generated based on condition information and user intention, which is input to a generative information processing model to cause the model to generate outing plan information.

The term “generative information processing model” refers to a trained computational model, such as a generative artificial intelligence model or machine learning model, configured to receive a prompt sentence and output text or structured data that represents an outing plan.

The term “outing plan information” refers to structured or semi-structured data describing an outing, including at least one of accommodation candidates, movement means, movement sections, scheduled visit regions, scheduled visit points, activities, and associated temporal information.

The term “accommodation facility” refers to a lodging-related service entity used during an outing, including but not limited to hotels, inns, guest houses, rental properties, or other lodging service providers.

The term “movement means” refers to a method or mode of transportation used to move between locations during an outing, including but not limited to public transportation, private vehicles, rental vehicles, ride-sharing, walking, or cycling.

The term “candidate information” refers to data specifying one or more options for accommodation facilities or movement means, derived from outing plan information or external systems, and presented to a user for selection.

The term “reservation processing information processing system” refers to an external or internal information processing system that manages reservation operations for services related to outings, including at least lodging services or transportation services, via an information communication network.

The term “reservation information” refers to data transmitted to a reservation processing information processing system for the purpose of confirming a reservation, including at least information concerning selected services, dates, times, and user identification.

The term “scheduled visit region” refers to a geographical region included in outing plan information, in which the user is planned to visit within a given time period according to the outing plan.

The term “schedule information” refers to temporal data included in outing plan information, indicating planned dates, times, or time periods for activities, movements, or visits in connection with an outing.

The term “weather information providing information processing system” refers to an external or internal information processing system configured to provide weather-related data, such as forecasts or current weather conditions, associated with a geographic region.

The term “weather information” refers to data indicating meteorological conditions of a region, including at least one of temperature, precipitation, wind, cloud cover, and weather forecasts associated with temporal information.

The term “movement section information” refers to data specifying a segment of movement in an outing, including at least an origin location, a destination location, and optionally an associated time or time period.

The term “route guidance information processing system” refers to an external or internal information processing system configured to provide route-related data, including movement routes, navigation guidance, and candidate movement means between locations.

The term “movement route” refers to a path or sequence of locations that connects an origin to a destination and that is used for movement during an outing.

The term “discount information providing information processing system” refers to an external or internal information processing system configured to provide information related to discounts, coupons, price reductions, or preferential offers associated with services or products.

The term “product information providing information processing system” refers to an external or internal information processing system configured to provide information related to products or goods, including at least local specialties, souvenirs, or merchandise relevant to an outing.

The term “discount information” refers to data describing a reduction in price, coupon availability, special offers, or promotional benefits related to services or products in association with an outing.

The term “product information” refers to data describing characteristics, availability, or recommendations of products or goods, including at least type, price, location of purchase, and related attributes.

The term “traffic information providing information processing system” refers to an external or internal information processing system configured to provide traffic-related data, including at least congestion levels, travel times, incidents, or other movement-related conditions.

The term “traffic information” refers to data describing conditions of movement along roads or transportation networks, including at least a degree of congestion, estimated travel time, delays, or incidents.

The term “degree of congestion” refers to an indicator value representing how crowded or saturated a transportation route, area, or facility is, based on real-time or near real-time traffic-related data.

The term “route that avoids congestion” refers to a movement route calculated such that segments having a high degree of congestion are reduced or bypassed relative to an alternative route, while maintaining movement between an origin and a destination.

The term “state information” refers to data obtained from a sensor or input device that represents a physical, physiological, or behavioral condition of a user, including at least motion data, biometric data, operation patterns, or explicit feedback.

The term “sensor” refers to a hardware element that detects physical quantities or biological signals and outputs corresponding measurement data, including at least position sensors, motion sensors, image sensors, audio sensors, and biometric sensors.

The term “input device” refers to a hardware or software interface through which a user can provide information to an information processing apparatus, including at least touch screens, keyboards, pointing devices, microphones, and gesture-based input mechanisms.

The term “emotion information” refers to data representing an estimate of a user's emotional state, such as satisfaction, fatigue, stress, excitement, or boredom, inferred from state information acquired from a sensor or input device.

The term “dynamically change” refers to automatically modifying at least a part of outing plan information at execution time or runtime in response to new input, including but not limited to emotion information, traffic information, or updated condition information.

The term “information communication network” refers to a wired or wireless communication infrastructure that enables data transmission between the processor and external or internal information processing systems, including at least local networks and wide-area networks.

In one embodiment, a server cooperates with a terminal operated by a user to implement an outing planning system. The terminal is, for example, a smartphone, a tablet, or a personal computer executing an operating system such as a mobile operating system or a desktop operating system. The server is, for example, a virtual machine or container instance running on a cloud computing platform, equipped with one or more processors such as a central processing unit and, optionally, a graphics processing unit. The server executes middleware such as a web application framework (for example, a framework based on an interpreted language or a scripting language) and a trained generative AI model implemented using a machine learning framework such as a tensor-based numerical computation library.

The terminal acquires condition information from the user through an information input unit. The terminal provides graphical user interface controls such as text input fields, checkboxes, date selectors, and selection lists rendered by a user interface toolkit. The user operates the terminal to input condition information including at least destination, schedule, budget, number of participants, preferred activities, movement preferences, and accommodation preferences. The terminal stores the condition information in a structured in-memory representation, such as a key-value map or an object instance, and transmits the condition information to the server via a secure communication protocol over an information communication network.

The server receives the condition information and generates a prompt sentence. The server stores the received condition information in a data structure in a volatile memory, such as a random access memory, and then converts the condition information into a natural-language text by a template-based generation module. The server uses a rule set that maps each field of the condition information to a phrase segment and concatenates the segments into a prompt sentence. For example, the server may generate a prompt sentence such as: “Please generate an optimal travel plan for a weekend trip to a city within a specified budget, including accommodations, transportation, detailed schedule, weather considerations, discount opportunities, souvenir recommendations, and routes that avoid crowds.” The server may further refine the prompt sentence by inserting concrete city names, dates, and preferences according to the stored condition information.

The server inputs the prompt sentence into a generative AI model. In one embodiment, the generative AI model is a transformer-based neural network including multiple encoder-decoder layers or decoder-only layers, each layer comprising self-attention mechanisms, feed-forward sub-networks, normalization components, and residual connections. The server represents the prompt sentence as a sequence of tokens and embeds the tokens into high-dimensional vectors using an embedding matrix stored in a non-volatile storage device. The server applies the sequence of embedded vectors to the generative AI model, which has been trained off-line using gradient-based optimization on a corpus of text including itinerary descriptions, geographic information, and general language data.

The server causes the generative AI model to compute, for each token position, an attention distribution over preceding tokens and to propagate activations through multiple layers. The server uses a loss function such as cross-entropy during training to minimize prediction errors of next tokens and updates the model parameters using a gradient descent algorithm or a variant thereof, such as an adaptive moment estimation optimizer. The server may perform data augmentation during training by rephrasing itinerary texts or by injecting synthetic constraints. As a result, the trained model acquires the ability to map a prompt sentence to an output sequence representing an outing plan.

During inference, the server decodes the output sequence by sampling or beam search, generating outing plan information in the form of structured sections, such as day-by-day plans, lists of candidate accommodations, lists of candidate movement means, and associated times and locations. The server then post-processes the generated text by applying parsing rules, regular expressions, or a lightweight classification model to extract entities such as place names, time expressions, and cost estimates, and transforms the extracted entities into an internal structured representation. This internal representation may be implemented as a nested data structure including arrays of itinerary items, each itinerary item containing fields such as date, time slot, origin location, destination location, movement means, activity description, and optional meta-data such as expected cost and user preference tags.

The server integrates external information to refine the outing plan information. The server communicates via the information communication network with at least one reservation processing information processing system, at least one weather information providing information processing system, at least one route guidance information processing system, at least one discount information providing information processing system, at least one product information providing information processing system, and at least one traffic information providing information processing system. The server issues requests in a structured format containing parameters such as location identifiers, dates, and service categories. The server receives responses in structured messages and updates the internal data structure of the outing plan information by adding or modifying fields such as availability flags, real-time prices, forecast values, and congestion indicators.

The server obtains reservation-related data by sending candidate accommodation and movement segments, extracted from the outing plan information, to a reservation processing information processing system. The server receives available options and uses a scoring function that considers price, distance from planned activities, user preferences, and rating indicators. The server stores scores alongside each candidate in the internal representation. By representing candidates and scores in a shared structure, the server can filter and rank candidates efficiently, reducing the number of options presented to the user and thus reducing downstream processing and communication overhead between the server and the terminal.

The server obtains weather information by passing the scheduled visit regions and schedule information to a weather information providing information processing system. The server maps each planned activity to one or more time windows and retrieves weather forecasts corresponding to the geographic coordinates or region identifiers for those windows. The server inserts weather summary fields into each itinerary item, including temperature range, precipitation probability, and recommended clothing or equipment hints. By storing weather data in a normalized format, the server avoids repeated parsing of weather responses when the user adjusts only a subset of the plan, which reduces computation time when updating the plan.

The server obtains discount information and product information by transmitting location and time constraints to discount and product information providing information processing systems. The server receives discount items and product descriptions and attaches identifiers of relevant itinerary items to each discount or product entry. The server records the relationship between itinerary elements and discount/product entries in a link table or mapping structure, enabling queries such as “retrieve all discounts applicable to the second day's activities.” This data structure reduces search time and avoids recomputing matches when the user reopens the plan.

The server obtains route and traffic information by interacting with a route guidance information processing system and a traffic information providing information processing system. The server models the movement network as a graph representation stored in memory, where nodes correspond to locations such as stops, intersections, or facilities, and edges correspond to movement segments. The server assigns each edge a base cost, such as travel time or distance, and dynamically updates additional weights according to traffic information including degree of congestion. The server executes a pathfinding algorithm such as a Dijkstra algorithm or an A* algorithm on the weighted graph to compute an optimal route that balances a cost function defined as a combination of travel time, congestion, and user constraints. By updating edge weights based on traffic information and recomputing paths only for affected segments, the server reduces redundant computation compared to recalculating entire routes from scratch.

The server estimates emotion information based on state information acquired from sensors or input devices associated with the terminal. The terminal may include a motion sensor, an image sensor, an audio sensor, or a biometric sensor, and may also provide an interaction history such as touch patterns and response times. The terminal collects the sensor outputs and interaction metrics and uploads state information to the server at predetermined intervals or in response to events. The server applies an emotion estimation model, which may be a neural network trained on labeled emotion data, to map the state information to a probability distribution over emotion categories such as satisfaction, fatigue, stress, or boredom. The server then chooses an emotion label or a continuous emotion score according to a rule such as maximum probability or thresholding.

The server adjusts the outing plan information according to the estimated emotion information. For example, if the server detects that the user exhibits high fatigue, the server may modify the internal representation by inserting additional rest periods, shortening walking distances, or prioritizing movement means classified as low effort. If the server detects low satisfaction, the server may increase the diversity of activities or propose alternative attractions with higher predicted enjoyment scores. The server may compute those modifications by re-invoking the generative AI model with an updated prompt sentence that includes references to the current emotion state, such as “Please adjust the travel plan to reduce walking distance and increase rest time because the user is tired.” The server then merges the newly generated plan segments with the existing reservation and weather data by using identifiers and timestamps to preserve already confirmed reservations.

The terminal presents the outing plan information to the user in a structured interface. The terminal receives the structured data from the server, parses it, and renders multiple views such as a calendar view, a list view, and a map view. The terminal highlights elements such as confirmed reservations, recommended routes, weather annotations, discounts, and suggested products. The terminal may also locally cache the plan data in a storage component to reduce communication load and enable partial offline operation. By caching data, the terminal requests only incremental updates from the server when a small change occurs, thereby reducing network traffic and server-side processing load. The server improves technical performance relative to conventional systems in several ways. First, the server unifies the generation of an outing plan using a generative AI model and the subsequent refinement using multiple external information processing systems under a single data structure and control flow. This unification eliminates redundant data transformations and inconsistent state management that otherwise would occur if each subsystem maintained its own representation. Second, the server uses specific graph-based algorithms and structured link tables to optimize route computation and discount matching, which leads to reduced computation time and improved response times for user interactions. Third, the server exploits emotion information and real-time traffic information to selectively recompute only those portions of the plan that are likely to be affected, thereby reducing the number of calls to external systems and lowering network load. The generative AI model is not used merely to automate human planning, but to exploit intermediate representations and feature extraction that are difficult to implement manually. The server uses high-dimensional embeddings and attention patterns as implicit features of condition information and user preferences, enabling the model to infer non-obvious associations between activities, locations, and constraints. Such associations contribute to improved plan coherence and reduced conflicts, for example by avoiding overlapping time allocations or by aligning indoor activities with periods of adverse weather. By providing the generative AI model with structured prompt sentences that explicitly encode user constraints and context, and by post-processing the model output into a normalized data structure, the server achieves a level of computational consistency and scalability that human planners or purely rule-based systems cannot easily realize.

In another embodiment, the server may use a different model architecture, such as a recurrent neural network with long short-term memory units or a hybrid model that combines a transformer encoder with a graph neural network operating on a movement graph. The server may store part of the model parameters in a dedicated accelerator memory such as a graphics processing unit memory and may partition the model across devices to improve inference throughput. The server may also adjust decoding parameters such as temperature and beam width depending on the complexity of the plan, thereby balancing diversity and determinism of generated plans. Such control over model inference contributes to predictable latency and stable resource utilization on the server.

In another embodiment, the server may precompute partial plans for common patterns of condition information and store them in a cache. The server may compare a new prompt sentence to stored condition patterns using a similarity metric computed from embeddings, and may reuse a part of a stored plan as an initialization for the generative AI model or as a fallback when external systems are temporarily unavailable. This configuration further reduces processing time and improves robustness of the system.

In still another embodiment, the server may deploy separate generative AI models for different aspects of the outing plan, such as one model specialized in accommodation selection and another model specialized in route and activity arrangement. The server may coordinate these models by using a supervisory module that enforces global consistency constraints, such as budget limits and maximum travel times, through constraint satisfaction algorithms. The server may iterate between model outputs and constraint checking until a consistent plan is obtained. This modular approach allows the system to be extended or updated by replacing or retraining individual models without changing the entire pipeline.

By arranging the server, the terminal, and the generative AI model in this manner, the system achieves technical effects that go beyond a mere automation of human planning steps. The server reduces server-side and network-side resource consumption by centralizing data structures, executing optimized algorithms for route computation and matching of external information, and minimizing repeated accesses to external systems. The server improves the accuracy and relevance of outing plans by combining high-capacity generative modeling with structured post-processing and real-time contextual updates derived from weather, traffic, and emotion information. As a result, the system operates as an improved computer-based platform that processes large volumes of heterogeneous data more efficiently and provides more precise and adaptive planning results than conventional systems.

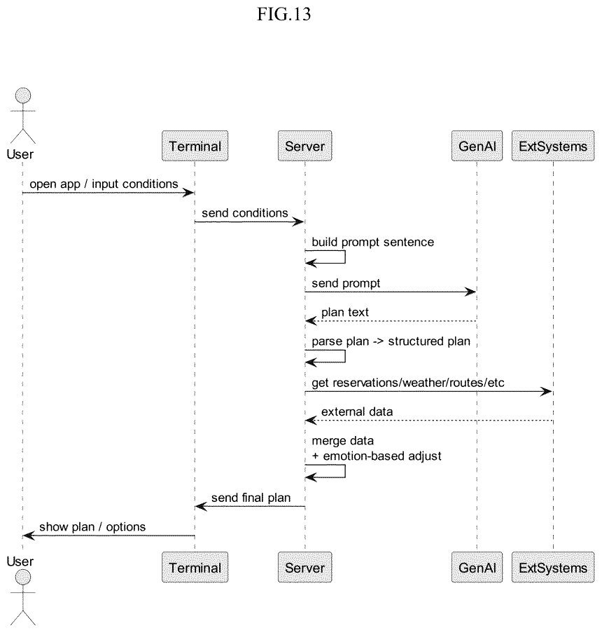

The following describes the processing flow using FIG. 13.

### Step 1:

The user activates an outing planning application on the terminal.

The terminal loads a graphical user interface and initializes internal data structures to store condition information. As input, the terminal receives no user data yet and only uses configuration data from local storage. As output, the terminal presents input fields for destination, schedule, budget, preferred activities, and movement and accommodation preferences.

### Step 2:

The user inputs condition information through the terminal.

The terminal receives, as input, user operations such as text entry, date selection, toggle selection, and list selection. The terminal performs validation operations by checking formats of dates, numeric ranges for budget, and completeness of mandatory fields. The terminal outputs validated condition information in a structured in-memory representation, for example a key-value map containing destination, dates, budget, number of participants, and preference lists.

### Step 3:

The terminal transmits the condition information to the server.

The terminal takes, as input, the validated condition information, and encapsulates it into a request object including a user identifier and a timestamp. The terminal performs data serialization to a structured message format and encrypts the message using a transport security protocol. The terminal outputs an encrypted request that is sent over an information communication network to an endpoint managed by the server.

### Step 4:

The server receives and stores the condition information.

The server accepts, as input, the encrypted request from the terminal, decrypts the communication stream, and parses the structured message to extract the condition information. The server performs data validation and normalization, such as converting date strings into a unified time representation and normalizing currency values. The server outputs normalized condition information stored in a volatile memory structure associated with the user session.

### Step 5:

The server generates a prompt sentence based on the condition information.

The server receives, as input, the normalized condition information. The server executes a template-based generation module that maps each field (destination, dates, budget, preferences) to phrase segments. The server concatenates these segments using grammar rules and, optionally, inserts additional guidance phrases required by the generative AI model. The server outputs a prompt sentence as a natural-language text, such as: “Please generate an optimal travel plan for a weekend trip to a specified destination within a specified budget, including accommodations, transportation, detailed schedule, weather considerations, discount opportunities, souvenir recommendations, and routes that avoid crowds.”

### Step 6:

The server inputs the prompt sentence to the generative AI model and generates initial outing plan text.

The server takes, as input, the prompt sentence, tokenizes the text into discrete tokens using a tokenizer, and maps tokens to embedding vectors using a stored embedding matrix. The server feeds the sequence of embedding vectors into a generative AI model, for example a transformer-based neural network, and performs forward propagation through multiple layers. The server executes attention computations and feed-forward operations to obtain a probability distribution over possible next tokens at each position. The server applies a decoding method such as beam search to select a sequence of output tokens. The server outputs a generated outing plan text that includes descriptions of daily schedules, accommodation candidates, movement means, and activity recommendations.

### Step 7:

The server parses the generated outing plan text into a structured plan representation. The server receives, as input, the generated outing plan text. The server applies text processing operations, such as pattern matching and entity extraction, to identify dates, time slots, place names, movement descriptions, and cost values. The server groups extracted entities by day and by movement section using parsing rules and temporal alignment. The server outputs a structured outing plan representation, implemented as a nested data structure containing itinerary items, each with fields for date, time, origin, destination, movement means, activity description, and estimated cost.

### Step 8:

The server requests reservation-related information from external reservation systems.

The server takes, as input, the structured outing plan representation, particularly the accommodation and movement segments. The server constructs query messages specifying locations, date ranges, capacity requirements, and other constraints. The server sends these messages over an information communication network to one or more reservation processing information processing systems. The server receives structured response messages containing availability and pricing information. The server executes scoring computations that combine price, rating, distance from planned activities, and user preferences to assign a score to each candidate option. The server outputs an updated plan representation that includes, for each accommodation and movement segment, a ranked list of reservation candidates with scores.

### Step 9:

The server integrates weather information into the outing plan.

The server receives, as input, the scheduled visit regions and schedule information from the structured plan representation. The server forms queries that specify geographic identifiers and time ranges and transmits them to a weather information providing information processing system. The server receives, as output from the weather system, forecast data including temperature, precipitation probability, and weather conditions over time. The server aligns the forecast data with itinerary items by matching time intervals and location identifiers and computes summary indicators such as daily temperature range and highest precipitation probability. The server outputs an augmented plan representation in which each itinerary item contains associated weather summary fields and advisory text.

### Step 10:

The server obtains discount information and product information relevant to the outing plan. The server takes, as input, the scheduled visit points and time periods from the structured plan. The server constructs search queries specifying locations, dates, and categories of interest, and sends the queries to discount information providing and product information providing information processing systems. The server receives structured lists of discount offers and product descriptions. The server evaluates the relevance of each item by comparing location proximity, validity periods, and category correspondence with itinerary items. The server builds a link mapping between itinerary items and applicable discounts or products. The server outputs a plan representation enriched with discount entries and product entries attached to relevant activities and locations.

### Step 11:

The server computes congestion-aware routes based on route and traffic information.

The server receives, as input, movement section information from the structured plan and real-time traffic information from a traffic information providing information processing system. The server constructs a graph representation whose nodes correspond to locations and whose edges correspond to movement segments. The server assigns each edge a base cost (for example, predicted travel time or distance) and then updates edge weights according to congestion indicators received from the traffic system. The server applies a pathfinding algorithm such as a Dijkstra algorithm or an A* algorithm to compute, for each movement section, a route that minimizes a cost function combining base cost and congestion penalty. The server outputs an updated plan representation that contains, for each movement section, one or more congestion-aware routes with step-by-step instructions.

### Step 12:

The server estimates user emotion information based on state information from the terminal. The server takes, as input, state information uploaded by the terminal, which may include sensor readings and interaction metrics such as motion patterns, response times, and touch pressure. The server preprocesses the state information by normalizing values, extracting statistical features over time windows, and encoding categorical events. The server applies an emotion estimation model, such as a neural network trained on labeled emotion data, and computes a probability distribution over emotion categories. The server selects an emotion label or score according to a predefined rule. The server outputs emotion information representing the user's estimated emotional state.

### Step 13:

The server modifies the outing plan based on the emotion information.

The server receives, as input, the emotion information and the current structured plan representation. The server applies decision rules that map emotion categories to modification actions, for example increasing rest periods for fatigue, reducing total walking distance for stress, or inserting more diverse activities for boredom. The server optionally generates a supplementary prompt sentence that summarizes the current plan and the desired modification, and re-invokes the generative AI model with this supplementary prompt sentence to produce alternative plan segments. The server merges the alternative segments with the existing plan by preserving confirmed reservations and necessary constraints. The server outputs a revised plan representation that reflects emotion-based adjustments.

### Step 14:

The server sends the finalized or updated outing plan to the terminal.

The server takes, as input, the structured plan representation including reservation candidates or confirmations, weather data, discount and product information, and congestion-aware routes. The server serializes the structured data into a compact message format, possibly applying compression or differential encoding if only partial updates are needed. The server transmits the message to the terminal over the information communication network. The server outputs a plan message optimized for display and local caching.

### Step 15:

The terminal presents the outing plan and related information to the user.

The terminal receives, as input, the serialized plan message from the server and decompresses and parses the message to reconstruct the structured plan data. The terminal maps the data to user interface components such as list views, calendar views, and map views, and renders elements such as itinerary items, reservation statuses, weather icons, discount badges, and suggested products. The terminal computes layout and formatting operations for efficient rendering and may store part of the plan in local storage for offline access. The terminal outputs a displayed, interactive plan that the user can review and modify.

### Step 16:

The user reviews the plan and performs further interactions through the terminal.

The terminal receives, as input, user actions such as approving reservations, selecting specific accommodation or transport candidates, enabling or disabling discounts, or requesting alternative routes. The terminal aggregates these interactions into update requests that describe desired changes, such as replacing a movement means, adjusting a time slot, or refining preferences. The terminal sends the update requests back to the server as structured messages. The terminal outputs user-confirmed selections and modified constraints, which serve as new inputs for further server-side processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented planning and navigation systems suffer from several technical limitations in how they process heterogeneous context data and generate personalized plans in real time. Typical systems handle user preferences, reservation data, map data, traffic data, weather data, and sensor data in separate, loosely coupled modules. As a result, such systems are generally configured to execute fixed, rule-based workflows that are not able to dynamically integrate these data sources at runtime based on changing user states, such as the user's emotional condition, or based on high-level natural-language goals expressed by the user.

First, conventional systems do not provide an efficient mechanism by which a computing apparatus can interpret a user's high-level intention, expressed in natural language, and directly convert that intention into machine-usable plan information. In many existing implementations, server-side logic requires rigid, form-based input, and substantial ad hoc code is necessary to translate between user-facing expressions of intent and internal data structures. This causes complexity in server programs, leads to duplicated logic for multiple scenario types (outing, travel, delivery, commuting), and makes the control flow brittle and difficult to maintain or extend.

Second, known systems generally treat emotion or user state information, when available at all, as an ancillary display feature rather than as a first-class input that affects the core computational decisions of the system. Emotion signals derived from sensors or input devices are not consistently integrated into the path selection algorithms, schedule adjustment routines, or resource reservation logic. Consequently, the processing pipelines of such systems remain largely static even when sensor data indicates that the user is fatigued, stressed, or excited, and cannot technically adapt their optimization criteria (for example, edge weights in a route graph or activity selection constraints) in response to these states.

Third, most existing routing and planning engines are optimized only for static criteria such as shortest distance or minimal travel time, and are not configured to coordinate multiple external information services-such as geographic information services, weather information services, reservation services, and traffic information services-in a single, unified processing pipeline. These engines typically query each service in isolation and apply simple post-hoc filtering, without computationally re-evaluating the entire route graph or timetable when external context (for example, congestion level, weather conditions, or resource availability) changes. This leads to technically inefficient use of network and compute resources, non-optimal route selection, and limited scalability when new data sources or optimization objectives are introduced. Fourth, even when generative models are employed, they are often used only at the user interface layer to produce textual recommendations, and not as a structured planning component within the core server architecture. Conventional architectures do not define a robust interface between a generative model and deterministic components such as reservation engines and route optimization modules. As a result, generative outputs are not consistently converted into structured plan information that can be directly consumed by downstream computation, and system behavior remains fragmented and error-prone.

Accordingly, there is a need for a computer-implemented system whose processor is configured to: (i) accept high-level prompt sentences encoding user intent; (ii) generate structured plan information by invoking a generative AI model; (iii) systematically integrate reservation services, geographic information services, traffic information services, and weather information services; and (iv) incorporate emotion information derived from sensor data into the adjustment of activity schedules, transport mode selection, and route computation. There is a further need for such a system to construct and update route graphs with weighted edges whose weights are dynamically modified based on both external context (weather, congestion, availability) and internal user context (emotion, preferences, history), thereby improving the technical operation of the planning and navigation functions executed by the processor.

The specific processing by the specific processing unit 290 of the data processing device 12 in Application Example 2 is realized by the following means.

The present invention provides a server comprising a processor, a communication interface, and a storage device, the processor being configured to receive, via the communication interface, a prompt sentence from a user terminal, the prompt sentence expressing a user intention for an outing plan or a movement plan; generate context information including the prompt sentence and user attribute information stored in the storage device; input the context information to a generative AI model to obtain plan information representing at least one of an outing plan and a movement plan in a structured format; access, via the communication interface, a reservation service to search for candidate lodging means or movement means corresponding to schedule elements included in the plan information; finalize reservations of selected resources by transmitting reservation information to the reservation service; acquire user state data from at least one acquisition device including an imaging device and an audio acquisition device associated with the user terminal or a vehicle-mounted apparatus; input the user state data to an emotion estimation model to generate emotion information representing a user emotional state; modify, based on the emotion information, at least one of an activity content, a time allocation, and a movement means included in the plan information; acquire route information and congestion information from a geographic information service; construct, in the storage device, a route graph for movement sections included in the plan information; select candidate routes and movement means by applying a weighted route search algorithm to the route graph using weights that reflect congestion levels and user preferences; dynamically adjust the weights according to the emotion information to recalculate an optimal route; acquire weather information from a weather information service; correct required times for activities or deliveries included in the plan information based on the weather information; update start times or estimated arrival times accordingly in the plan information; and integrate proposal information output from the generative AI model, reservation information, movement route information, weather information, and emotion information into integrated plan information in a format suitable for presentation on the user terminal, and transmit the integrated plan information to the user terminal. This enables the server to technically improve the generation and execution of personalized plans by unifying generative AI processing with deterministic reservation and routing algorithms, by dynamically adjusting route graph weights and schedule parameters based on real-time emotion, traffic, and weather data, and by reducing the computational complexity and brittleness of conventional rule-based planning pipelines.

The term “prompt sentence” refers to a natural-language input string provided by a user or generated by a system, which expresses at least a user intention or requirement for an outing plan, movement plan, delivery plan, or related operation, and which is used as an input condition for a generative AI model.

The term “user attribute information” refers to information stored in a storage device that characterizes a user, including at least one of demographic information, preference information, restriction information, and historical usage information, and that is used as context when generating or adjusting a plan.

The term “context information” refers to information generated by combining a prompt sentence with related data, including at least user attribute information, current environmental information, and system state information, and that is supplied as input to a generative AI model in order to obtain structured output.

The term “generative AI model” refers to a data processing model implemented by software and/or hardware that, in response to input data such as a prompt sentence and context information, generates output data including at least one of plan information, proposal information, and explanatory information by using machine learning techniques.

The term “plan information” refers to structured data representing at least one of an outing plan, a movement plan, a delivery plan, or a composite of such plans, including schedule elements, activities, locations, movement sections, and resource usage.

The term “reservation service” refers to a network-accessible information processing service that receives reservation information for at least one of lodging means, transportation means, vehicles, seats, or facilities, and that returns reservation results including confirmation information.

The term “reservation information” refers to data transmitted to a reservation service for the purpose of booking a resource, including at least a resource identifier, a date and time, a quantity, and user identification information.

The term “lodging means” refers to a resource that provides accommodation for a user, including at least one of a lodging facility type, a room type, and a stay period, and that can be reserved through a reservation service.

The term “movement means” refers to a resource or method that enables a user to travel between locations, including at least one of a public transportation service, a private vehicle, a hired vehicle, or a walking route, and that may be selected or reserved by the system.

The term “user state data” refers to sensor-derived or input-derived data associated with a user, including at least one of image data, audio data, motion data, and explicit user input, which is used for estimating a user's emotional or physical state.

The term “acquisition device” refers to a hardware component or a combination of hardware components configured to acquire user state data, including at least one of an imaging device, an audio acquisition device, a motion sensor, or a similar sensor.

The term “imaging device” refers to an image-capturing component such as a camera that acquires still image data or moving image data representing at least part of a user or an environment.

The term “audio acquisition device” refers to a sound-capturing component such as a microphone that acquires audio data representing at least one of a user's voice and surrounding sounds.

The term “emotion estimation model” refers to a data processing model that receives user state data as input and outputs emotion information indicating an estimated emotional state of the user by applying statistical or machine learning techniques.

The term “emotion information” refers to data representing at least one aspect of a user's emotional state, including labels such as fatigue, stress, joy, or excitement, and optionally associated confidence values or intensity values.

The term “emotion engine” refers to a processing module that uses emotion information as input to adjust or control other processing, including at least modification of plan information, selection of movement means, or adjustment of environment settings.

The term “user preference information” refers to data indicating user likes, dislikes, constraints, and priorities, including at least one of preferred activity types, preferred transportation modes, budget ranges, dietary restrictions, or comfort preferences.

The term “geographic information service” refers to a network-accessible service that provides data related to geographic locations, including at least map data, route information, and congestion information for use in route computation.

The term “route information” refers to data describing at least one path between geographic points, including a sequence of waypoints, distances, estimated travel times, and route attributes associated with the path.

The term “congestion information” refers to data indicating at least one of traffic density, travel speed, occupancy level, or crowd level on a segment of a route or at a location, and that is used to estimate congestion levels.

The term “movement section” refers to a portion of a plan information object that represents travel between two locations, such as travel from a starting point to a destination or between scheduled activities.

The term “movement route” refers to a specific path selected for a movement section, including details such as intermediate nodes, distances, and estimated travel times.

The term “weather information service” refers to a network-accessible service that provides weather-related data, including at least weather forecasts, precipitation data, and temperature data for specified locations and times.

The term “weather information” refers to data obtained from a weather information service, including at least the type, intensity, and timing of weather conditions at given locations relevant to activities or movement.

The term “required time” refers to an estimated time interval necessary to complete a specified activity, movement section, or delivery, computed based on context such as distance, traffic, and weather conditions.

The term “start time” refers to a time at which a specified activity, movement section, or delivery is scheduled to begin according to plan information.

The term “estimated arrival time” refers to a time at which a specified activity, movement section, or delivery is predicted to complete or arrive at a destination according to plan information.

The term “proposal information” refers to data output from a generative AI model that expresses at least one of recommended activities, recommended facilities, candidate movement routes, or narrative explanations related to a plan.

The term “integrated plan information” refers to data obtained by combining plan information with proposal information, reservation information, movement route information, weather information, and emotion information, and formatted for presentation or subsequent processing.

The term “history summary information” refers to data summarizing at least part of a user's past usage history, order history, or movement history, expressed in a form suitable for input to a generative AI model as a component of context information.

The term “usage history information” refers to data representing a record of past interactions by a user with a system, including at least past plans, confirmations, rejections, or modifications.

The term “order history information” refers to data representing a record of past selections or orders by a user for goods or services, including at least past restaurant choices, menu selections, and purchase attributes.

The term “movement history information” refers to data representing a record of past trips or movements by a user, including origins, destinations, routes taken, travel modes used, and associated times.

The term “facility candidates” refers to a plurality of potential facilities, such as lodging facilities, eating facilities, or activity facilities, which may satisfy the user intention and are generated or selected for consideration by the system.

The term “activity candidates” refers to a plurality of potential activities, such as visits, events, or experiences, which may be included in a plan according to the user intention and constraints.

The term “movement means candidates” refers to a plurality of potential movement modes or combinations of modes, such as walking, public transport, private vehicle, or hired vehicle, which are considered by the system for a movement section.

The term “actual-environment location information” refers to data describing real-world locations of facilities, transportation resources, and users, including coordinates, addresses, and spatial relationships.

The term “availability information” refers to data indicating whether a resource such as a facility, service, or route is usable at a particular time, including open/closed status, seat availability, or service capacity.

The term “constraint conditions” refers to one or more conditions that limit or influence plan generation and selection processes, including at least budget, time windows, legal restrictions, and user-specified exclusions.

The term “route graph” refers to a graph data structure whose nodes represent geographic points or states, and whose edges represent possible movement segments with associated weights related to travel cost, time, or comfort.

The term “weighted route search algorithm” refers to a computational procedure that searches a route graph to find at least one path optimized according to edge weights, such as a shortest path algorithm or a lowest-cost path algorithm.

The term “navigation application program” refers to a software application executed on a user terminal or vehicle apparatus that presents route guidance, including at least map display, turn-by-turn instructions, and route updates.

In an embodiment, a server executes a planning and navigation system that integrates a generative AI model, deterministic optimization modules, and multiple external information services. The server comprises at least one processor, a memory storing program code and data, and a network interface. The server operates in cooperation with a terminal and with one or more sensors mounted on the terminal or on a vehicle.

The terminal functions as a user interface device and may be implemented by a smartphone, a tablet, an in-vehicle computing unit, or a general-purpose computer. The terminal includes a display device, an input device such as a touch panel or keyboard, an imaging device such as a camera, and an audio acquisition device such as a microphone. The terminal executes an application that communicates with the server via a communication network, acquires user inputs including prompt sentences and explicit preferences, and presents integrated plan information received from the server.

The user operates the terminal to input a prompt sentence. The user may also allow the terminal to acquire image data, audio data, and location data. The user does not need to specify low-level parameters such as exact times or routes; instead, the user provides high-level, natural-language goals such as travel objectives, desired atmosphere, budget constraints, and current feelings.

### 1. System Configuration and Program Structure

The server executes a plurality of software modules including: a prompt-processing module, a context-construction module, a generative AI interface, a reservation module, an emotion-analysis module, a routing module, a weather-adjustment module, an integration module, and a data-management module. The memory of the server stores data structures including: user attribute information, user history data, plan information, reservation information, movement route information, weather information, and emotion information.

The server implements the generative AI model interface as a network client to a model-hosting environment executing a large-scale neural network. In one embodiment, the generative AI model is a transformer-based sequence model having multiple attention layers, feedforward layers, and normalization layers. The generative AI model receives tokenized representations of prompt sentences and context information, and outputs token sequences that are decoded into structured text such as JSON-like plan descriptions or lists of candidates.

The server implements the emotion estimation model as a separate neural network, which may be a convolutional neural network (CNN) for image data and a recurrent neural network (RNN) or transformer model for audio data, or a multi-modal network combining features extracted from image and audio inputs. The emotion estimation model receives vectors derived from user state data and outputs numerical values representing probabilities of different emotion classes, such as fatigue, stress, calmness, joy, or excitement.

The server stores user attribute information and history data in a relational or document-oriented database. User history data includes usage history information, order history information, and movement history information. The server maintains indexes on user identifiers and timestamps to permit efficient retrieval and aggregation of history for prompt preparation.

### 2. Data Representations and Feature Construction

The server represents plan information as hierarchical data structures. Each plan includes a plurality of days or time segments. Each day includes activities and movement sections. Each activity entry includes attributes such as location identifier, start time, end time, type (for example, sightseeing, dining, rest), and cost estimates. Each movement section entry includes an origin location, a destination location, candidate movement means, and associated route identifiers.

The server represents a route graph as a directed graph data structure stored in memory. Nodes in the graph represent geographic waypoints, transportation stops, or activity locations. Edges in the graph represent possible movements between nodes and store weights including at least travel time, distance, cost, and comfort scores. The routing module adjusts the edge weights dynamically according to congestion information, weather information, and emotion information.

The server constructs features for the generative AI model and for deterministic models. For example, the server encodes user preferences as a vector containing: normalized budget range, preferred activity categories, preferred movement means, sensitivity to walking distance, and tolerance to crowded environments. The server encodes emotion information as a vector of probabilities across emotion classes. The server concatenates or otherwise combines these feature vectors with tokenized text to create a rich context for the generative AI model.

### 3. Generative AI Model Configuration and Learning

The server, or a model-hosting component connected to the server, uses a transformer-based generative AI model including an embedding layer, a plurality of self-attention layers, and a final projection layer. The model is trained using supervised learning on training examples that pair input sequences (prompt sentences and structured context) with output sequences (desired plan structures or proposals). The training process uses a cross-entropy loss function that measures the difference between predicted token distributions and target tokens. During training, the server adjusts model parameters using gradient-based optimization such as stochastic gradient descent with adaptive learning-rate methods.

The server may further fine-tune the generative AI model using domain-specific data for travel, movement, and delivery scenarios. During fine-tuning, the server applies data augmentation to create varied examples of prompt sentences and plans, including different phrasings and constraints. This fine-tuning increases the model's ability to generate structured output that matches the required fields of plan information, thereby reducing the need for complex error-correction logic and improving computational efficiency.

The server configures the generative AI model to use constrained decoding strategies. For example, the server may apply beam search with penalties on tokens that break JSON structure, or enforce that certain key names and types appear in the output. This allows the generative AI model to act not only as a text generator but as a structured plan generator that outputs content directly consumable by deterministic modules.

### 4. Emotion Estimation Model Configuration and Learning

The server or a model-hosting environment trains the emotion estimation model using labeled datasets comprising pairs of user state data (images, audio segments) and emotion labels. The emotion estimation model may use convolutional layers to extract visual features (for example, facial landmarks, eye openness, mouth curvature) and recurrent or attention layers to extract temporal patterns from sequences of frames or audio samples.

The training process uses a classification loss function such as categorical cross-entropy. The server applies regularization techniques such as dropout and weight decay to prevent overfitting. The server may also apply data augmentation such as random cropping, rotation, or noise addition to increase robustness to variations in lighting, angle, and background noise.

During inference, the server receives feature vectors produced by a pre-processing module on the terminal or on the server. The emotion estimation model outputs probability values for each emotion class. The server or terminal then selects the dominant emotion label, and the server stores the emotion information in association with the user and time in the database.

### 5. Deterministic Routing and Optimization Algorithms

The server uses the routing module to compute movement routes and to adapt them to context. The routing module constructs a route graph by querying a geographic information service for base map data and real-time traffic and congestion information. The routing module assigns initial weights to edges based on travel time and distance. The routing module further adjusts weights by multiplying or adding penalty values derived from congestion levels, such as slower speeds or blocked segments. The routing module modifies weights based on emotion information and user preference information. For example, if the emotion information indicates fatigue, the routing module increases weights on edges with long walking distance or numerous transfers, thereby causing the weighted route search algorithm to avoid those edges. If the emotion information indicates excitement and the user has a preference for scenic walks, the routing module decreases weights on edges associated with scenic paths, even if they are slightly longer.

The routing module applies a weighted route search algorithm such as Dijkstra's algorithm or A* search. The algorithm processes the route graph stored in memory, scanning neighbors of nodes, updating tentative distances, and selecting nodes with minimum cumulative weight. The use of dynamically adjusted weights causes the algorithm to compute different routes when emotion or external conditions change, without altering the core algorithmic structure. This improves the adaptability of the routing process while maintaining predictable computational complexity.

### 6. Integration with Reservation and Weather Services

The server uses the reservation module to integrate with external reservation services. The reservation module formats reservation information in accordance with the external service's interface and sends requests via the network. The reservation module then parses returned data structures containing confirmation numbers, resource identifiers, and time ranges, and stores these data as reservation information in the database.

The server uses the weather-adjustment module to integrate with weather information services. The weather-adjustment module queries forecast data for locations in the plan and for the relevant dates and times. The weather-adjustment module then computes correction factors for required times of movement sections and activities. For example, the module may increase required time values when heavy rain or snow is forecast, and may decrease time for certain outdoor activities when weather is favorable.

The weather-adjustment module updates the start times and estimated arrival times in the plan information. The server then re-invokes the routing module if changes in required times cause scheduling conflicts. This coordinated adjustment reduces the likelihood of missed connections or delays and improves the robustness of the overall plan.

### 7. Program Operation and Technical Effects

The server processes prompt sentences to reduce the need for complex, rule-based interpretation logic. For example, the user may input a prompt sentence such as:

“I want to plan a 3-day trip from Tokyo to Kyoto next month for two adults. Budget is 100,000 yen. I like temples, quiet cafés, and scenic walks. Please avoid crowded places.” or:

“Based on my past orders and today's mood text ‘I'm exhausted and stressed,’ recommend dinner options, adjust delivery time for current weather and traffic, and choose a delivery route that minimizes delays.”

The server collects user attribute information, including preferences and past history, and constructs context information. The generative AI model then outputs a structured description of candidate activities, facilities, and movement sections. Because the generative AI output is already organized into machine-readable fields, the server avoids numerous string parsing and heuristic matching operations that traditional systems require. This reduces CPU usage and memory fragmentation, which improves throughput.

The server further improves computational efficiency by offloading a portion of planning logic to the generative AI model, which operates on compressed, learned representations of schedules and preferences. The model uses attention mechanisms to directly focus on relevant parts of the context, which is more efficient than enumerating all combinations of activities, times, and routes by explicit iterated loops. As a result, the server can generate plans for complex scenarios with fewer iterations and smaller search spaces than conventional combinatorial schedulers.

By integrating the emotion estimation model into the routing and planning pipeline, the server modifies internal edge weights, candidate lists, and scheduling constraints at a low level. This integration differs from mere presentation of emotion to the user. The emotion information directly affects the cost function used in the route search algorithm and the selection of movement means. For example, when the emotion information indicates fatigue, the routing module increases the cost of long walks and multiple transfers and reduces the cost of comfortable means such as hired vehicles. This re-weighting process reduces the probability of selecting routes that the user will later reject, thereby decreasing the number of re-planning operations and network calls needed. Consequently, computational resources and communication bandwidth are conserved.

The server also utilizes history summary information when constructing prompts for the generative AI model. The server compresses large volumes of past data into summaries that capture key patterns, such as average budget, typical travel distance per day, and preferred restaurant types. The server then includes these summaries in the prompt sentences passed to the generative AI model. This mechanism reduces the amount of raw history data that must be transmitted or processed, thus lowering storage access and network overhead while maintaining a high degree of personalization. Because the server constructs an integrated plan that unifies reservation information, movement route information, weather information, and emotion information, the data-management module can maintain a single coherent data structure for each plan. This design avoids inconsistent states that arise in systems where each component maintains its own partial view. It also enables efficient incremental updates; when weather or traffic changes occur, the server updates only affected segments in the plan information and does not need to recompute the entire plan from scratch.

### 8. Use of the System in Real-World Technical Environments

The server is configured not merely to generate abstract itineraries but to control or coordinate real-world devices and processes. For example, when the server selects a movement route suitable for a tired user, the server sends route instructions to a navigation application program on the terminal or an in-vehicle unit. The navigation application program then guides the user or vehicle along the computed route, using map displays and audio instructions. In another embodiment, the server transmits configuration data to a vehicle's internal control system to adjust cabin lighting or audio settings according to emotion information.

By using the generative AI model to produce structured plans and using deterministic modules to enforce constraints and perform routing on route graphs, the server achieves better technical performance than a purely rule-based system or a purely human-driven process. The server reduces latency by avoiding repeated human interactions to clarify preferences; instead, the generative AI model interprets high-level prompts in a single pass. The server also increases accuracy of estimated travel times by combining weather-adjusted required times with congestion-aware routing, resulting in fewer prediction errors.

The system is not limited to business logic or human task automation. The core improvements occur at the level of data representation, algorithmic control, and integration of multiple computing services. The server uses specialized data structures (route graphs, plan information trees, feature vectors) and machine-learning models trained for these structures. The flow and combination of these computations, driven by emotion information and generative outputs, changes the actual operation of the computer system: memory access patterns, network call timing, and path selection in graphs are all adaptively controlled.

### 9. Variations and Alternative Embodiments

The server may implement different neural network architectures for the generative AI model, including encoder-decoder transformers, auto-regressive decoders, or mixture-of-experts models. The server may adjust the number of layers, hidden units, and attention heads according to available hardware and latency constraints. The server may also deploy quantized or pruned versions of the model to reduce inference time while maintaining sufficient planning accuracy.

The emotion estimation model may be implemented as separate models for image and audio modalities, with a fusion layer combining outputs from the separate models. Alternatively, the server may use only one modality, such as facial expressions, if audio data is not available. The classification threshold for emotion labels may be adjusted according to user feedback to optimize the trade-off between sensitivity and false positives.

The routing module may support additional criteria in the edge weights, such as environmental impact or cost caps, and may apply multi-objective optimization algorithms. In some embodiments, the server constructs multiple route graphs for different transport modes and uses a higher-level graph to model transfers between graphs. This enables the server to compute multimodal routes that account for walking, public transport, and vehicles within the same optimization framework.

In another embodiment, the server deploys parts of the processing on the terminal. For example, the terminal may perform local pre-processing of user state data, including face detection and feature extraction, and send only pre-extracted features to the server. This reduces network bandwidth usage and allows faster emotion estimation. The server may also cache partial results of generative AI calls for common prompt patterns, thereby further reducing latency.

The user may use the system not only for leisure trips but also for daily commuting, logistics, or food delivery. The same program structure operates across these scenarios by interpreting prompt sentences, constructing context, invoking the generative AI model, and applying deterministic modules to produce integrated plan information. In food delivery scenarios, the system uses the same mechanism to adjust delivery times and delivery routes based on weather information and congestion information while taking into account the user's emotional state and past order history.

Through these embodiments and variations, the server, terminal, and user cooperate to realize a system that uses a generative AI model and prompt sentences not only to generate human-readable recommendations, but to drive concrete modifications in route graphs, schedule parameters, and resource reservations. This results in technical improvements in computation, such as reduced processing time for complex planning tasks, more accurate travel time estimates, decreased need for re-planning, and more efficient use of network and processor resources, thereby enabling the invention to be implemented as a practical and improved computer technology.

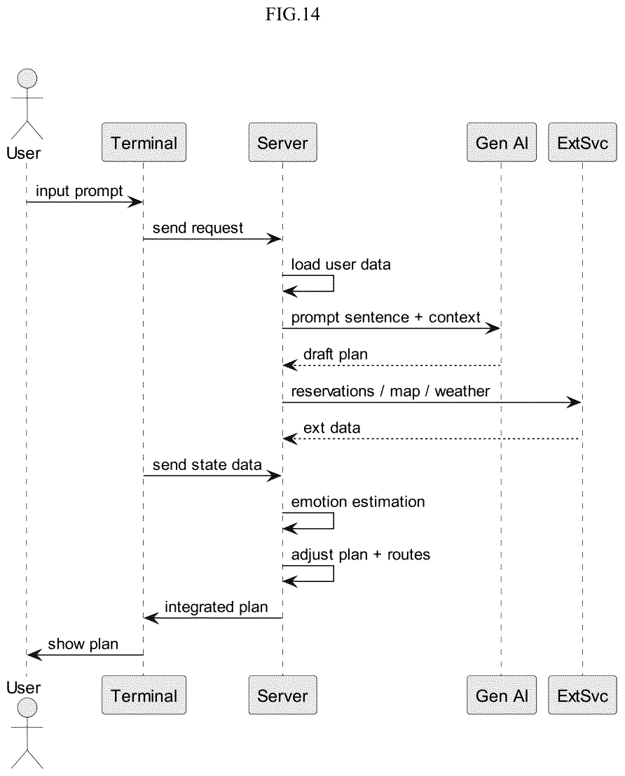

The following describes the processing flow using FIG. 14.

### Step 1:

User operates the terminal to input a prompt sentence and basic preferences.

User launches an application on the terminal and enters a natural-language prompt sentence, such as “I want to plan a 3-day trip from city A to city B next month” or “Based on my past orders and today's mood ‘I'm exhausted and stressed,’ recommend dinner options and adjust delivery time.” User may also select structured options such as dates, budget, origin, destination, and preferred movement means.

Input: user's prompt sentence, structured preference fields (dates, budget, locations), and user identifier.

Output: a request object on the terminal containing the prompt sentence, the structured fields, and a timestamp.

Terminal packages this information into a data structure (for example, a JSON object), attaches authentication tokens, and prepares it for transmission to the server.

### Step 2:

Terminal transmits the request and context data to the server.

Terminal sends the request object to the server via a secure communication protocol over a network.

Terminal may also attach device information (for example, platform type, locale) and current location coordinates obtained from a location sensor.

Input: request object including prompt sentence, preferences, user identifier, device information, and location.

Output: a network message delivered to the server's communication interface.

Terminal converts internal data structures into a serialized format, performs encryption if required, and invokes a network stack to send the message to a server endpoint.

### Step 3:

Server receives the request and retrieves user attribute information and history.

Server accepts the network message, validates authentication, and parses the serialized data into an internal request structure. Server uses the user identifier to query a storage device for user attribute information and history data, including usage history, order history, and movement history.

Input: parsed request structure (prompt sentence, preferences, user identifier, location) and stored user attribute and history records from the database.

Output: a combined context record containing the current request data, user attribute information, and aggregated history statistics.

Server performs data-processing operations such as filtering history by time range, counting frequency of activities, and computing average budgets, thereby generating summary values used as features for subsequent processing.

### Step 4:

Server constructs context information and prepares the generative AI prompt.

Server generates context information by merging the prompt sentence, user attribute information, and history summaries into a unified representation. Server then constructs a detailed prompt sentence for the generative AI model that includes high-level user intentions and machine-readable constraints.

Input: combined context record (prompt sentence, user attributes, history summaries).

Output: a model-ready prompt sentence and associated structured context fields.

Server formats the prompt sentence as a text sequence that encodes constraints (for example, “3 days,” “budget limit,” “avoid crowded places”) and may embed serialized summary information, reducing later search space in downstream modules.

### Step 5:

Server calls the generative AI model and obtains draft plan information or candidates.

Server sends the prepared prompt sentence and optional structured context to a generative AI model executing locally or on an external model host. The model processes the tokenized input through its network layers and outputs a sequence representing structured plan information or a list of candidates.

Input: model-ready prompt sentence and structured context fields.

Output: generated text representing draft plan information, such as activities per day, facility candidates, or movement means candidates.

Server receives the generated output, decodes the token sequence into text, and, if applicable, parses the text into a structured intermediate representation with fields corresponding to activities, resources, and time slots.

### Step 6:

Server validates and normalizes the generated plan information.

Server analyzes the generated content for structural correctness and consistency. Server checks that required fields (for example, locations, times, categories) are present, and normalizes place names and facility names by querying geographic information and resource databases.

Input: generated draft plan information from the generative AI model.

Output: normalized plan information containing internal identifiers for locations, facilities, and time segments.

Server performs data-processing operations such as name matching, time-format normalization, and mapping of textual labels to numeric or symbolic codes, thus converting free-form generative output into machine-usable data structures.

### Step 7:

Server interacts with reservation services to generate reservation information.

Server inspects the normalized plan information to identify elements requiring reservations, such as lodging means or movement means. Server then formats reservation queries and sends them to one or more reservation services through the network.

Input: normalized plan information (with candidate lodging and movement segments) and user constraints (budget, dates, capacity).

Output: reservation options and, upon confirmation logic, reservation information including confirmation numbers and resource identifiers.

Server receives candidate reservation responses, performs data calculations such as cost comparison, availability checks, and time compatibility analysis, and selects suitable options based on optimization rules. Server then sends reservation confirmation requests and stores returned confirmation data in the database.

### Step 8:

Terminal and sensors acquire user state data for emotion estimation.

Terminal, optionally in conjunction with a vehicle-mounted device, activates an imaging device and an audio acquisition device to capture user state data. Terminal records short sequences of video frames and audio segments while respecting user permissions.

Input: real-time image data and audio data representing the user's face and voice.

Output: pre-processed user state data suitable for emotion analysis.

Terminal may apply pre-processing such as face detection, cropping, frame selection, noise reduction, or feature extraction, and then sends either the raw or pre-processed data to the server or a dedicated emotion estimation service.

### Step 9:

Server estimates emotion information from user state data.

Server receives user state data or feature vectors and feeds them into an emotion estimation model.

The model processes the data through convolutional or recurrent layers to produce probability distributions over emotion classes.

Input: user state data or extracted features (visual features, audio features).

Output: emotion information including at least one emotion label and associated probability values.

Server selects a dominant emotion label according to decision criteria (for example, maximum probability above a threshold) and saves this emotion information in association with the user and the current plan.

### Step 10:

Server adjusts plan information based on emotion information and preferences.

Server uses the emotion information and user preference information to modify the plan information.

For example, if fatigue is detected, the server may replace intensive activities with more relaxed activities, or change movement means to reduce walking.

Input: current plan information, emotion information, and user preference information.

Output: adjusted plan information with updated activity content, time allocations, and movement means.

Server executes data operations that reassign activities to different time slots, add or remove rest periods, and update resource selections according to pre-defined adjustment rules that are indexed by emotion class.

### Step 11:

Server constructs a route graph and obtains route and congestion data.

Server queries a geographic information service for route information and congestion information corresponding to the origins and destinations in the plan information. Server then constructs or updates a route graph in memory, where nodes represent locations and edges represent movement segments.

Input: adjusted plan information (including locations and movement sections) and external geographic and congestion data.

Output: a route graph with edges weighted according to baseline travel times and congestion levels.

Server computes edge weights by combining raw travel-time estimates with congestion metrics, and stores these weights as numeric attributes for each graph edge, enabling subsequent route search algorithms to compute costs efficiently.

### Step 12:

Server computes movement routes using a weighted route search algorithm.

Server runs a weighted route search algorithm, such as Dijkstra or A*, on the route graph to compute optimal movement routes. The cost function for each edge incorporates base travel time, congestion penalty, and optional preference and emotion-derived penalties.

Input: route graph with weighted edges and configuration parameters for cost computation (weights for time, congestion, comfort).

Output: candidate movement routes and associated metrics (total cost, travel time, number of transfers, walking distance).

Server performs repeated exploration of nodes and updates tentative distances according to the cost function, thereby generating paths that optimize for the selected criteria.

### Step 13:

Server updates edge weights based on emotion information and recalculates optimal routes.

Server modifies edge weights in the route graph to reflect user emotion. For example, server increases weights on edges with long walking distance when fatigue is detected and reduces weights on comfortable or scenic segments when appropriate. Server then re-runs the weighted route search algorithm.

Input: route graph, emotion information, and user preference information.

Output: emotion-adjusted optimal routes with updated metrics.

Server computes new weighted costs by applying emotion-specific factors and re-evaluates paths. This recalculation yields routes that better match the user's current condition and reduces the likelihood of later route changes.

### Step 14:

Server obtains weather information and corrects required times.

Server queries a weather information service for forecast data at the locations and times relevant to activities and movement sections. Server maps weather conditions to time correction factors.

Input: schedule information from the plan and weather forecast data for corresponding regions and time intervals.

Output: corrected required times and updated start and estimated arrival times for activities and movements.

Server performs data computations such as adding delay margins for heavy rain or snow and adjusting outdoor activity durations. Server then updates the time-related fields in the plan information.

### Step 15:

Server generates integrated plan information for presentation.

Server aggregates all processed information: plan information obtained from the generative AI model, reservation information, adjusted routes, weather corrections, and emotion information.

Server compiles these into integrated plan information formatted for display on the terminal.

Input: adjusted plan information, reservation information, movement route data, weather information, and emotion information.

Output: integrated plan information including a coherent schedule, route details, confirmed reservations, and contextual notes.

Server constructs hierarchical or structured data that groups activities by day, attaches map data for each movement section, and includes explanation texts where needed.

### Step 16:

Server transmits the integrated plan information to the terminal.

Server sends the integrated plan information to the terminal via the network interface, using a structured data format. Server may also segment the information into sections appropriate for progressive display.

Input: integrated plan information and terminal identification.

Output: a network response carrying plan data to the terminal.

Server may compress the data, handle pagination, and maintain a session identifier allowing the terminal to request incremental updates.

### Step 17:

Terminal presents the integrated plan and supports user interaction.

Terminal receives the integrated plan information and renders it on the display as a timeline, list, and map views. Terminal also shows contextual details such as reservations, weather expectations, and route explanations.

Input: integrated plan information from the server.

Output: graphical and textual representations of the plan on the display, with interactive controls for user feedback and modifications.

Terminal parses the structured data into internal view models, maps route polylines to graphical elements, and binds user interface controls to enable selection of options, acceptance of reservations, or generation of follow-up prompt sentences.

### Step 18:

User reviews the plan, provides feedback, and optionally issues follow-up prompt sentences.

User examines the displayed plan, confirms or rejects certain activities or routes, and may enter additional instructions such as “Replace this restaurant with a vegetarian option nearby” or “Show a more scenic route because I feel better now.”

Input: displayed plan information and user interactions such as taps, selections, and new prompt sentences.

Output: updated user commands and modified preferences, which the terminal packages into new request objects.

Terminal gathers the user's selections, updates local preference indicators, and, when required, generates new requests that contain follow-up prompt sentences and modified constraints for transmission back to the server, thereby initiating further iterations of the planning and optimization process.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

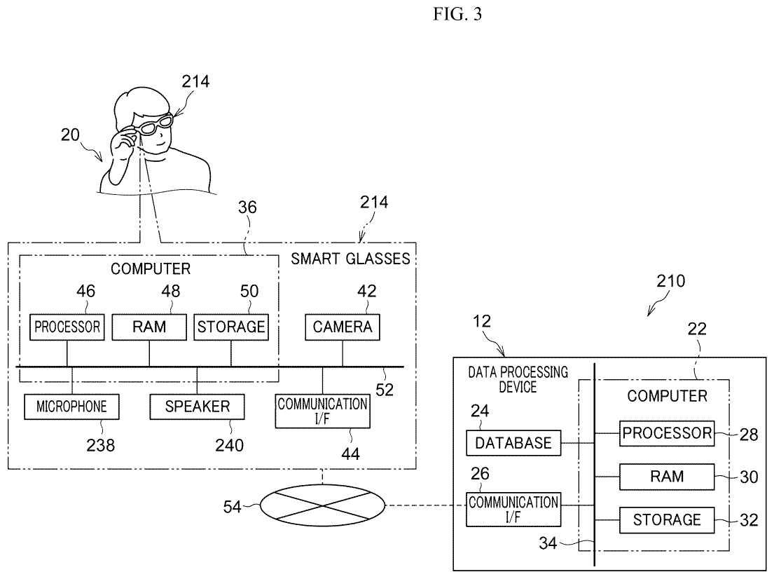

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

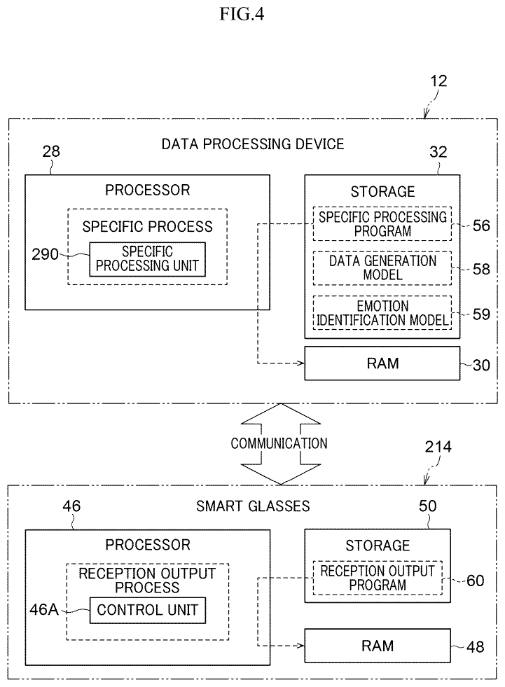

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

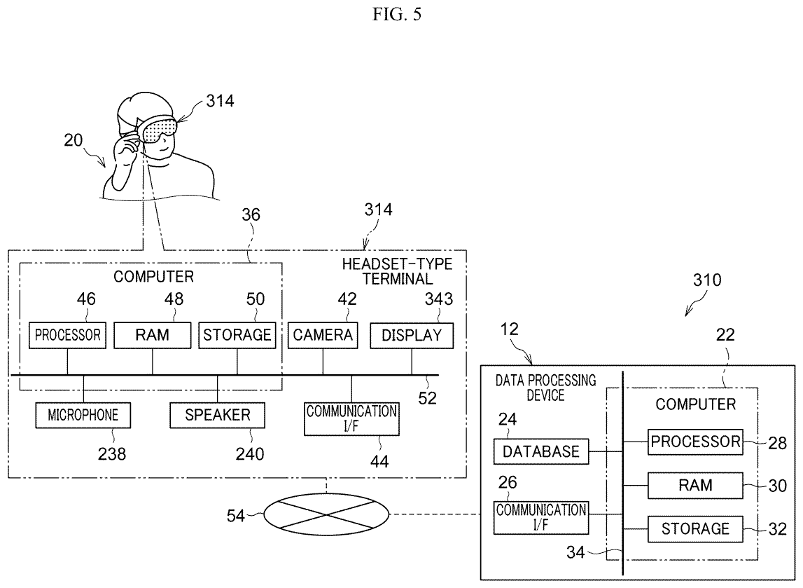

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

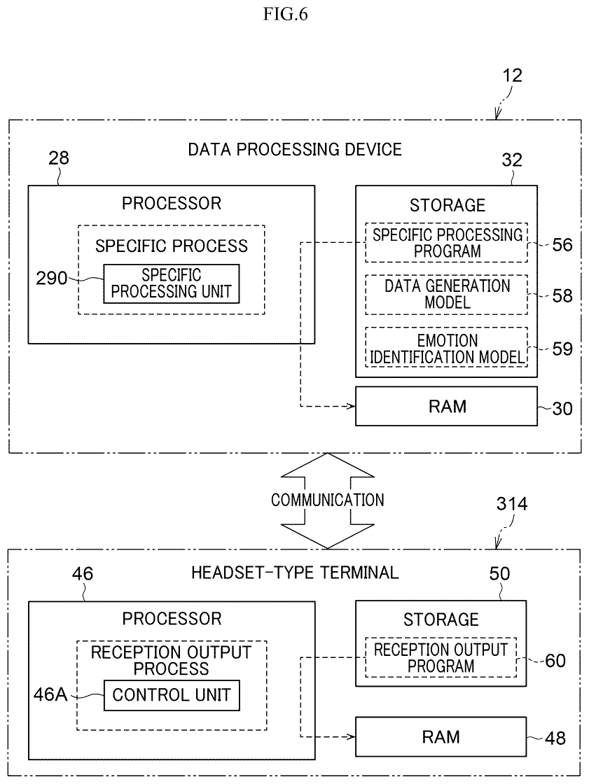

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

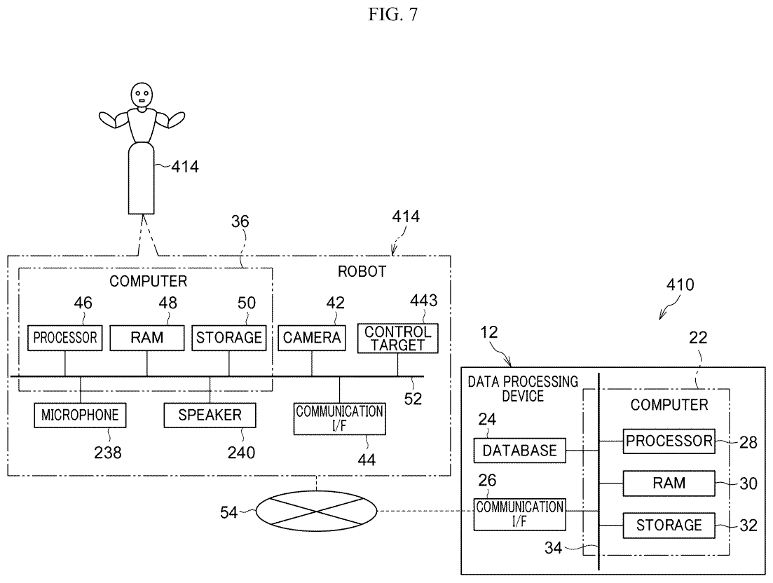

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

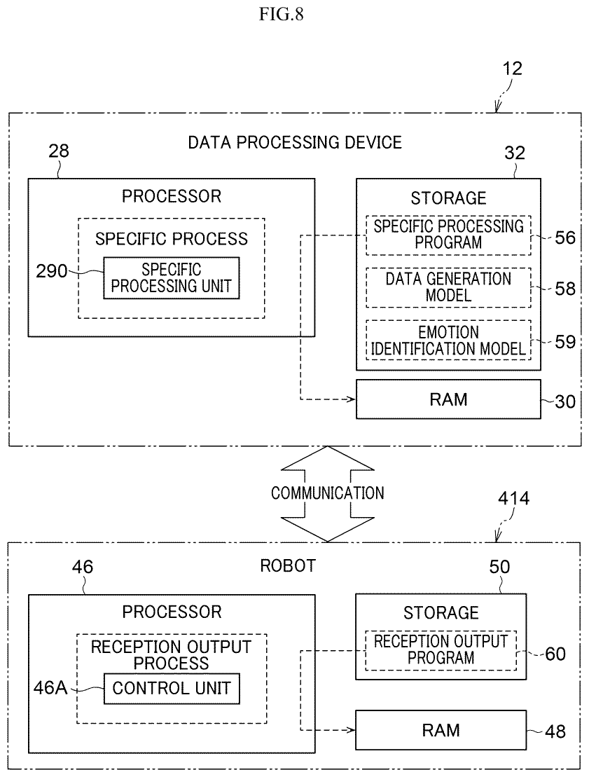

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

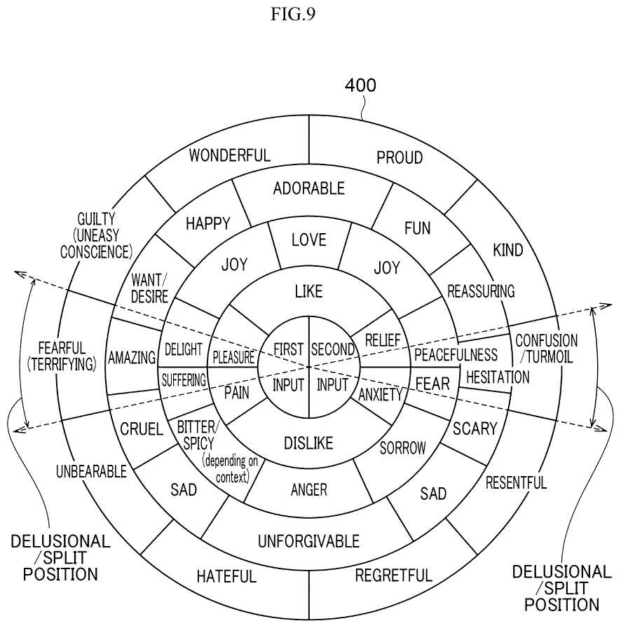

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

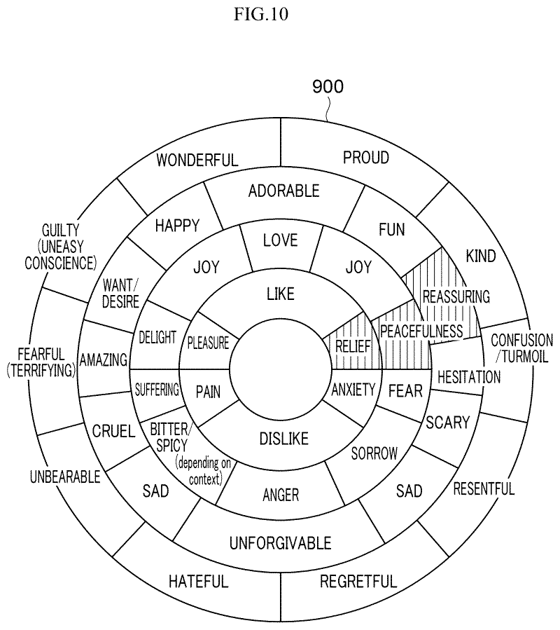

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a user terminal, user preference information relating to an outing and to input the user preference information as a natural language prompt sentence, and to construct the prompt sentence as input data for a generative AI model,
generate, by using an information processing apparatus including the generative AI model, an outing plan as structured data on the basis of the prompt sentence and at least one of historical behavior information or preference information, the outing plan including at least a candidate visiting location, a time allocation, and a cost allocation,
extract, from the generated outing plan, reservation request information corresponding to at least one of an accommodation behavior or a movement behavior, call, via a communication network, an interface of an external reservation processing apparatus, obtain candidate information of at least one of an accommodation service or a movement service, confirm a reservation on the basis of the candidate information, and store reservation identification information in association with the outing plan,
acquire, from an external weather information providing apparatus, weather information corresponding to a location and a date and time included in the outing plan, and integrate the weather information as additional information corresponding to each action segment of the outing plan,
acquire, from a route search processing apparatus, movement route information corresponding to a current position of a user and each movement section included in the outing plan, and store the movement route information in association with the outing plan,
acquire, from an external congestion information providing apparatus, congestion degree information for an area or route corresponding to the movement route information, compare the congestion degree information with a predetermined threshold, and, when a high congestion degree is determined, reacquire alternative route information by using the route search processing apparatus and dynamically update the outing plan to include a movement route having a lower congestion degree,
acquire, from an external benefit information providing apparatus, discount information or benefit information corresponding to at least one of a location, a date and time, or a usage type included in the outing plan, and integrate the discount information or the benefit information in association with each action segment in the outing plan,
acquire, from a regional information database, region-specific item information or tourism resource information corresponding to a region included in the outing plan, and add the region-specific item information or the tourism resource information in association with at least one of a stay segment or a purchase segment in the outing plan,
generate emotion information by an emotion analysis unit configured to analyze an emotional state of the user acquired via at least one of a sensor or an input device, and, on the basis of the emotion information and the outing plan generated by the generative AI model, dynamically adjust contents of the outing plan including at least one of a visiting order, a stay time, or an activity type by using an emotion engine, and
generate integrated behavioral plan data obtained by integrating the outing plan, the reservation identification information, the weather information, the movement route information, the discount information, the region-specific item information, and the congestion degree information, and transmit the integrated behavioral plan data to the user terminal.

### (Supplementary 2)

The system according to supplementary 1,
wherein the processor is configured to, when generating the prompt sentence, acquire, from a database, at least one of past outing history information or usage history information of the user, add context information including the history information to the prompt sentence, and thereby cause the generative AI model to generate the outing plan reflecting a preference of the user.

### (Supplementary 3)

The system according to supplementary 1,
wherein the processor is configured to, when the outing plan generated by the generative AI model does not conform to a predetermined data structure, generate a regeneration prompt sentence obtained by correcting the prompt sentence, input the regeneration prompt sentence to the generative AI model, and regenerate the outing plan in a structured data format.

### Application Example 1

### (Supplementary 1)

A system comprising a processor,
wherein the processor is configured to
acquire departure position information and destination position information from a user terminal, and calculate movement route information on the basis of the departure position information and the destination position information,
acquire environment information including weather information corresponding to the movement route information from an external information providing apparatus, associate the environment information with the movement route information, and dynamically adjust the movement route information on the basis of the environment information,
acquire behavior history information and preference information from a user history information storage apparatus, and analyze the behavior history information and the preference information to generate user characteristic information,
generate a prompt sentence in a natural language as input information including at least the destination position information, the movement route information, the environment information, and the user characteristic information, and instruct a generative AI model to generate an outing plan by using the prompt sentence, and generate outing plan information on the basis of outing plan configuration information received from the generative AI model,
coordinate with an external reservation processing apparatus on the basis of stay candidate location information included in the outing plan information, transmit and receive reservation processing information related to facility use or movement means, and generate reservation confirmation information,
estimate a congestion degree index on the basis of the movement route information and the environment information, and calculate congestion-avoidance movement route information that avoids a high-congestion area or a high-congestion time zone on the basis of the congestion degree index,
integrate the outing plan information, the reservation confirmation information, and the congestion-avoidance movement route information, and generate integrated display outing plan information to be presented to the user terminal, and
monitor changes in the environment information and in the congestion degree index at predetermined time intervals, when the changes satisfy a predetermined condition, update the prompt sentence to include information corresponding to the changes, instruct the generative AI model to regenerate the outing plan, and update the integrated display outing plan information on the basis of regenerated outing plan information.

### (Supplementary 2)

The system according to supplementary 1,
wherein the processor is configured to
include preference category information and congestion-avoidance tendency information, which are included in the user characteristic information, in the prompt sentence, acquire, from the generative AI model, the stay candidate location information and recommended visit time period information in a structured data format, and generate the outing plan information on the basis of the structured data format.

### (Supplementary 3)

The system according to supplementary 1,
wherein the processor is configured to
add weather change information included in the environment information and congestion status change information included in the congestion degree index to the prompt sentence, give to the generative AI model an instruction for changing the outing plan including at least reduction of outdoor activity candidate information or replacement of the outdoor activity candidate information with indoor activity candidate information, and update the integrated display outing plan information on the basis of changed outing plan configuration information received from the generative AI model.

### Example 2

### (Supplementary 1)

A system comprising a processor,
wherein the processor is configured to
receive, through an information input unit, condition information relating to an outing, the condition information being input by a user via an information processing apparatus,
generate, based on the condition information acquired through the information input unit, a prompt sentence including the condition information, and input the prompt sentence to a generative information processing model so as to generate outing plan information,
present, to the user, candidate information for an accommodation facility or a movement means included in the outing plan information generated by the processor, call, via an information communication network, a reservation processing information processing system based on a selection result by the user, transmit reservation information relating to the accommodation facility or the movement means, and confirm a reservation,
call, via the information communication network, a weather information providing information processing system based on a scheduled visit region and schedule information included in the outing plan information, acquire weather information corresponding to the scheduled visit region, and present the weather information to the user in association with the outing plan information, call, via the information communication network, a route guidance information processing system based on movement section information included in the outing plan information, acquire, for a movement section, a plurality of movement routes and candidate movement means, and propose a movement means according to a condition of the user relating to movement,
call, via the information communication network, at least one of a discount information providing information processing system and a product information providing information processing system based on a scheduled visit point or time period included in the outing plan information, acquire discount information or product information related to the scheduled visit point, and present the discount information or the product information to the user in association with the outing plan information,
call, via the information communication network, a traffic information providing information processing system based on the movement section information and real-time traffic-related information, acquire traffic information including a degree of congestion, calculate a route that avoids congestion according to the degree of congestion, and reflect the calculated route in a route request to the route guidance information processing system so as to propose the route to the user, and
estimate emotion information based on state information of the user acquired from a sensor or an input device, and dynamically change the outing plan information generated by the processor in accordance with the emotion information.

### (Supplementary 2)

The system according to supplementary 1,
wherein the processor is configured to
generate, as the prompt sentence, a sentence including the condition information and intention of the user, input the prompt sentence to the generative information processing model to create the outing plan information, and automatically adjust content of the outing plan information based on the emotion information estimated by the processor.

### (Supplementary 3)

The system according to supplementary 1,
wherein the processor is configured to
perform inter-application coordination with an information processing apparatus including a navigation information processing program, calculate an optimal route in consideration of real-time congestion information acquired from the traffic information providing information processing system, and present the optimal route to the user via the navigation information processing program.

### Application Example 2

### (Supplementary 1)

A system comprising a processor,
wherein the processor is configured to
receive, from a user terminal, a prompt sentence that reflects a user intention to generate an outing plan or a movement plan, generate context information including the prompt sentence and user attribute information, and input the context information to a generative AI model to generate plan information representing the outing plan or the movement plan,
use a reservation service provided via a network to search, based on the plan information, for candidates of lodging means or movement means corresponding to scheduled lodging or scheduled movement included in the plan information, input reservation information according to a selection made by the user, and confirm a reservation of the lodging means or the movement means via the reservation service,
acquire user state data from an acquisition device including an imaging device or an audio acquisition device provided in the user terminal or a vehicle-mounted apparatus, generate emotion information representing a user emotional state by inputting the user state data to an emotion estimation model, and dynamically change, based on the emotion information, at least one of an activity content, a time allocation, and a movement means included in the plan information by using an emotion engine,
acquire route information and congestion information from an information processing apparatus that provides a geographic information service, generate, for each movement section included in the plan information, candidates of movement routes and movement means in consideration of a congestion level, and select an optimal movement route and an optimal movement means from among the candidates by using the emotion information and user preference information,
acquire weather information from an information processing apparatus that provides a weather information service, correct a required time related to an activity or a delivery included in the plan information by using the weather information, and reflect a corrected start time or a corrected estimated arrival time in the plan information, and
integrate proposal information output from the generative AI model, the reservation information, the movement route, the weather information, and the emotion information to generate integrated plan information in a format displayable on the user terminal, and transmit the integrated plan information to the user terminal.

### (Supplementary 2)

The system according to supplementary 1,
wherein the processor is configured to add history summary information, which summarizes at least one of past usage history information, order history information, and movement history information of the user, to the prompt sentence to be input to the generative AI model, cause the generative AI model to generate, based on the history summary information and current emotion information, a plurality of candidates of facility candidates, activity candidates, or movement means candidates, and apply actual-environment location information, availability information, and constraint conditions to the candidates in order to perform filtering and ranking of the candidates.

### (Supplementary 3)

The system according to supplementary 1,
wherein the processor is configured to, with respect to a movement route or a delivery route included in the integrated plan information, generate a route graph by using traffic information and congestion information acquired from a traffic information service, apply a weighted route search algorithm to the route graph to calculate an optimal route, change weights related to at least one of a walking section, a number of transfers, and comfort of a movement means according to the emotion information, recalculate the optimal route based on the changed weights, and present a result of the recalculated optimal route to the user in real time in cooperation with a navigation application program.

What is claimed is:

1. A system comprising:
circuitry configured to:
receive, via a communication interface coupled to a packet-switched network, condition data transmitted from a terminal device, convert the condition data into a normalized structured data set, and store the normalized structured data set in a storage device;
generate, based on the normalized structured data set, a natural-language prompt sentence by inserting parameter values derived from the normalized structured data set into predetermined positions of a sentence template, and transmit the natural-language prompt sentence to a generative neural network model to obtain generated output data;
convert the generated output data into a hierarchical structured data format comprising a plurality of segments organized by temporal divisions, each segment including at least an activity identifier, a time allocation, and an associated attribute set; and
transmit the hierarchical structured data format to the terminal device via the communication interface.

2. The system according to claim 1, wherein the circuitry is further configured to parse the condition data to extract a plurality of parameter fields, normalize each parameter field by converting values into a standardized representation, and calculate derived parameter values from the plurality of parameter fields before generating the normalized structured data set.

3. The system according to claim 2, wherein the sentence template includes control instructions specifying at least one of a detail level of the generated output data, types of activities to include, a suppression condition for a duration parameter, and an output format constraint, and the circuitry is configured to select or modify the sentence template based on the normalized structured data set.

4. The system according to claim 3, wherein, when the generated output data does not conform to the hierarchical structured data format, the circuitry is configured to generate a regeneration prompt sentence by appending format correction instructions to the natural-language prompt sentence, transmit the regeneration prompt sentence to the generative neural network model, and iteratively refine the generated output data until the generated output data conforms to the hierarchical structured data format.

5. The system according to claim 4, wherein the condition data includes travel schedule information, a number of participants, a departure location, an arrival location, a budget, and a transportation method, and the derived parameter values include a number of days calculated from a start date and an end date, and the circuitry is configured to generate the natural-language prompt sentence to instruct the generative neural network model to produce a travel itinerary plan organized on a per-day basis.

6. The system according to claim 1, wherein the circuitry is further configured to query the storage device using search condition data derived from the normalized structured data set, extract a plurality of candidate data items matching the search condition data, and perform ranking processing on the plurality of candidate data items based on a degree of match to generate ranked candidate list data.

7. The system according to claim 6, wherein the circuitry is configured to transmit the ranked candidate list data to the terminal device, receive a selection input from the terminal device indicating at least one selected candidate data item, and generate the natural-language prompt sentence incorporating attribute information of the selected candidate data item together with the normalized structured data set.

8. The system according to claim 7, wherein the circuitry is configured to receive, from the terminal device, a user-composed natural-language query together with the selection input, extract from the user-composed natural-language query at least one of a schedule change request, a cost adjustment request, an activity type change request, and a preference modification request, and incorporate the extracted request into extended generation instruction information included in the natural-language prompt sentence for the generative neural network model.

9. The system according to claim 1, wherein the circuitry is further configured to acquire supplementary context data from at least one external information providing apparatus coupled to the packet-switched network, the supplementary context data including at least one of weather information and event information corresponding to location identifiers and time values in the hierarchical structured data format, and associate the supplementary context data with corresponding segments of the hierarchical structured data format.

10. The system according to claim 9, wherein the circuitry is configured to generate a secondary natural-language prompt sentence based on the hierarchical structured data format and the supplementary context data, transmit the secondary natural-language prompt sentence to the generative neural network model, and receive secondary generated output data comprising a plurality of supplementary service option records, each supplementary service option record being associated with a corresponding temporal division and segment of the hierarchical structured data format.

11. The system according to claim 10, wherein the supplementary service option records comprise food and beverage delivery options grouped by date and meal category, and the circuitry is configured to validate each delivery option against provider information stored in the storage device or acquired from an external service providing apparatus, assign provider identification information, price information, and delivery time slot information to each validated delivery option, and transmit arrangement request data to the external service providing apparatus based on a selection input received from the terminal device.

12. The system according to claim 1, wherein the circuitry is further configured to receive, from the terminal device, user state data comprising at least one of expression data captured by an imaging sensor, voice data captured by an audio sensor, and physiological data captured by a biometric sensor, and estimate an emotional state of a user by inputting the user state data to an emotion identification model that maps input feature vectors to emotion values on an emotion map having a valence dimension and an arousal dimension.

13. The system according to claim 12, wherein the circuitry is configured to adjust a priority ranking of candidate data items or segments within the hierarchical structured data format by applying weighting based on the estimated emotional state, and dynamically change constraint conditions of the sentence template in accordance with the estimated emotional state to cause the generative neural network model to produce generated output data reflecting the emotional state.

14. The system according to claim 1, wherein the circuitry is further configured to receive, from the terminal device, correction input data indicating a modification to the hierarchical structured data format, update the normalized structured data set based on the correction input data, regenerate the natural-language prompt sentence based on the updated normalized structured data set, and transmit the regenerated natural-language prompt sentence to the generative neural network model to obtain updated generated output data.

15. The system according to claim 14, wherein the hierarchical structured data format includes, for each temporal division, a data structure comprising at least an activity content field for each of a plurality of time zones within the temporal division, a recommended facility field, a weather-related annotation field, and an event-related annotation field, and the circuitry is configured to transmit the data structure to the terminal device for rendering in a display format separated by day and by time zone.

16. The system according to claim 1, wherein the terminal device comprises one of a smart device, smart glasses, a headset-type terminal, or a robot, and the circuitry is configured to transmit the hierarchical structured data format in a format adapted to an output modality of the terminal device.

17. The system according to claim 16, wherein the circuitry is further configured to receive, from the terminal device, a selection of a segment within the hierarchical structured data format,
acquire settlement information related to the selected segment, and execute a purchase process by transmitting settlement request data to an external settlement processing apparatus coupled to the packet-switched network and receiving settlement confirmation data from the external settlement processing apparatus.

18. A system comprising:
circuitry configured to:
receive, via a communication interface coupled to a packet-switched network, condition data transmitted from a terminal device including at least schedule information, a participant count, a location parameter, and a preference parameter, convert the condition data into a normalized structured data set by parsing parameter fields, normalizing values into standardized representations, and calculating derived parameter values, and store the normalized structured data set in a storage device;
query the storage device using search condition data derived from the normalized structured data set to extract a plurality of candidate data items, perform ranking processing on the candidate data items based on a degree of match, transmit ranked candidate list data to the terminal device, and receive a selection input indicating a selected candidate data item;
generate a natural-language prompt sentence by inserting parameter values from the normalized structured data set and attribute information of the selected candidate data item into predetermined positions of a sentence template that includes control instructions specifying a detail level and an output format, and transmit the natural-language prompt sentence to a transformer-based generative neural network model;
convert generated output data received from the transformer-based generative neural network model into a hierarchical structured data format comprising a plurality of segments organized by temporal divisions, each segment including at least an activity identifier, a time allocation, a recommended facility identifier, and associated supplementary context data acquired from at least one external information providing apparatus;
receive user state data from the terminal device, estimate an emotional state by inputting the user state data to an emotion identification model, adjust a priority ranking of segments within the hierarchical structured data format based on the estimated emotional state, and regenerate the natural-language prompt sentence incorporating the estimated emotional state when a change in the emotional state exceeds a predetermined threshold; and
transmit the hierarchical structured data format to the terminal device via the communication interface for rendering in a display format organized by temporal division.

19. The system according to claim 18, wherein the circuitry is further configured to generate a secondary natural-language prompt sentence based on the hierarchical structured data format to obtain supplementary service option records from the transformer-based generative neural network model, validate each supplementary service option record against provider information, and transmit arrangement request data to an external service providing apparatus based on a selection input received from the terminal device.

20. A method performed by circuitry of a server coupled to a packet-switched network via a communication interface, the method comprising:
receiving, via the communication interface, condition data transmitted from a terminal device, converting the condition data into a normalized structured data set, and storing the normalized structured data set in a storage device;
generating, based on the normalized structured data set, a natural-language prompt sentence by inserting parameter values derived from the normalized structured data set into predetermined positions of a sentence template, and transmitting the natural-language prompt sentence to a generative neural network model to obtain generated output data;
converting the generated output data into a hierarchical structured data format comprising a plurality of segments organized by temporal divisions, each segment including at least an activity identifier, a time allocation, and an associated attribute set; and
transmitting the hierarchical structured data format to the terminal device via the communication interface.
